(19) United States
(12) Patent Application Publication
(10) Pub. No.: US 2013/0151280 A1
(43) Pub. Date: Jun. 13, 2013

(54) SYSTEM AND METHOD FOR CLINICAL RESEARCH CENTER NETWORK BUILDING AND USE

(71) Applicants: Fabio Alburquerque Thiers, New York, NY (US); Guilherme Bertini Boettcher, Porto Alegre (BR); Henrique Martins da Silva, Rio Claro (BR); Daniel Borges Martines, Lexington, MA (US)

(72) Inventors: Fabio Alburquerque Thiers, New York, NY (US); Guilherme Bertini Boettcher, Porto Alegre (BR); Henrique Martins da Silva, Rio Claro (BR); Daniel Borges Martines, Lexington, MA (US)

(21) Appl. No.: 13/708,342

(22) Filed: Dec. 7, 2012

Related U.S. Application Data
(60) Provisional application No. 61/569,098, filed on Dec. 9, 2011.
(60) Provisional application No. 61/695,797, filed on Aug. 31, 2012.

(51) Int. Cl. G06Q 50/02; G06F 19/00

(52) U.S. Cl. CPC G06Q 50/02; G06F 19/36
USPC 705/2

(57) ABSTRACT

The invention generally relates to computer-based systems for evaluating and marketing clinical trial research centers. In certain aspects, the invention provides computer-based systems for collecting information about clinical research centers. Systems include a tangible, non-transitory memory coupled to a processor operable to retrieve information identifying global networks of clinical trial capacity.

### CROSS-REFERENCE TO RELATED APPLICATIONS

This application claims priority to, and the benefit of U.S. Provisional Applications 61/695,797, filed Aug. 31, 2012, and 61/569,098, filed Dec. 9, 2011, the contents of each of which are incorporated by reference herein in their entirety.

### FIELD OF THE INVENTION

The invention generally relates to computer-based systems for evaluating and marketing clinical trial research centers.

### BACKGROUND

Sometimes, when a person is suffering from a life-threatening disease, the drug that would save that person's life has already been discovered and described by research scientists. However, government regulatory agencies will not allow the person to take the drug until that drug has been shown safe and effective in clinical trials. Those trials are regulated by the government and typically require double-blind, placebo controlled experiments on thousands of patients.

Planning a satisfactory clinical trial can take years and millions of dollars. After a study is designed, a patient population must be found with enough people to provide statistically significant results. Researchers who plan studies often seek to involve several clinical research centers in a so-called multicenter trial. Participating centers must be staffed by competent investigators and must have access to patients suited to the trial. Due to the difficulty in finding study participants and investigators, trial planning is very costly. Kraus, C., Low hanging fruit in infectious drug development, Curr Op Microbiol 11:434-438 (2008).

Study planners look for research centers by writing and mailing feasibility questionnaires. These forms have questions about prior study experience, patient availability, and other data relevant to the proposed study. However, many feasibility questionnaires go unanswered and a low percentage of them lead to initiation of trials at the site. Burgess & Sulzer, Examining the clinical trial feasibility process and its implication for a trial site, J Clin Trials 3:51-54 (2011). Even if feasibility questionnaires are completed and returned, trial planners still have only short-listed a few centers that may or may not prove satisfactory. At best, the short list puts a trial planner in a position to make speculative projections about patient recruitment. Dingankar, Clinical trial feasibility: analysis and evaluation, Modern Pharmaceuticals, March 2011, 50-51.

Due to the time, cost, and unpredictability of site selection, drug companies do not sponsor clinical trials for many otherwise promising drugs. When drug companies do sponsor a study, they must spend millions of dollars and months, even years, trying to identify research centers to participate in the trials. While the sponsors are mired in that process, people are suffering from the diseases that those drugs would target.

### SUMMARY

The invention employs the insight that a clinical trial planner is ultimately interested in availing themselves of clinical capacity as embodied in a global network of research centers and investigators. Accordingly, the invention provides systems and methods of documenting, modeling, and accessing a global network of clinical research capacity. Since the connections between research entities (e.g., investigators, research centers, others, or a combination thereof) could establish the relevant capacity to perform a multisite trial, but is poorly documented and becomes virtually inaccessible to the public as time goes by, the invention provides a system that analyzes and records relevant clinical trial connections and provides an interactive digital tool for mapping clinical capacity onto a proposed multisite trial. If a clinical trial is being considered, the most relevant information may be, for example, that four specific research centers had been used in a series of clinical trials conducted by a few certain co-collaborators in a past decade. The necessary documentation to establish that information may never be simultaneously all available to the public, but for a tool that analyzes and documents networks of clinical capacities. Since the “moving wall” policies of some publications and the non-searchable format of some archives makes some capacity information unavailable, and since some critical links between network nodes exist only in the memories of individual investigators, robust network information is only provided by a tool that accesses information when available and stores it, retrieves information from non-searchable formats, and encourages investigator participation. Systems and methods of the invention retrieve and store data for subsequent use and also analyze non-text-searchable documents, while additionally including the contributions of investigators, to provide a digital search tool representing a global network of clinical capacity. Since clinical trials can be initiated more rapidly, drugs are brought to market sooner, and suffering is alleviated while lives are also saved. Further, due to the immense cost savings afforded by rapid global site pre-qualification, drug costs are kept low, making more medications accessible to a greater number of people. Further, the invention also provides systems and methods for disease-specific marketing of clinical research centers.

In certain aspects, the invention provides a method for compiling a network for research centers that involves using a computer system to retrieve data describing a clinical trial in which a plurality of entities collaborated, analyze the data to identify each of the entities, and to compose, for each entity, a list of trials in which that entity collaborated. A profile including the list is provided for each entity, creating a network tool for realizing clinical capacity.

The entities that are profiled include researchers (e.g., physicians), research centers (e.g., physical locations), research institutions, personnel, or a combination thereof. The retrieved data can be database data (e.g., from the clinical trials registry web site of the United States government), publication data (e.g., publication bibliography data from a library of medicine web site), publications (e.g., PDF files or text files copied from outside sources over the internet), web pages (e.g., of the entities), other sources, or a combination thereof. Computer systems can operate to analyze the data and identify the contents. For example, non-text files can be analyzed by OCR programs. Files that include data without markup tags can be analyzed by regular expressions (e.g., ([A-Z][a-z]{+})\s([A-Z])\.\s([A-Z][a-z]{+}) can return first name, middle initial, and last name for $1, $2, and $3, respectively when a file is analyzed using regular expression using, for example, Perl, and the results can optionally be verified against a directory of existing content). Contents can be identified based on files that include markup, such as XML tags, which indicate the nature of portions of content.

The information in the list may further optionally be edited by a person. For example, the list may be a list of nodes to whom the person is connected in a network. The person may be allowed to log in and view their connections and add or edit them. In some embodiments, the list is provided in a profile that has one or more such list. For example, a profile can include a list of Dr. Smith's clinical collaborators and a list of Dr. Smith's institutional affiliations. Within the list as displayed in the profile, each entry can operate as a link taking a user to a profile for the listed entity. The invention benefits from the insight that people have inherent motivation to attend to public content relating to themselves, and will be biased towards updating their profile to display their full network. Since the network ultimately reflects clinical research capacity as distributed around the globe, and the network is maintained in-part automatically by the server and in-part by the contributions of the represented people, the network provides an up-to-date and accurate tool for searching for clinical capacity for a multi-site clinical trial.

Preferably, each investigator (e.g., Dr. Smith) is allowed to update their profile—amending their connections and also benefiting from the network. An investigator may find a convenient link to a co-collaborator from a clinical trial performed in the past.

In related aspects, the invention provides a method of using a clinical research center network in which a server computer system stores a profile describing a physician and a multisite clinical trial at a research center that the physician has participated in and receives data from the physician establishing a link between the physician and a second multisite clinical trial. The server operates to update the profile to include the data and the link and to provide a clinical trial planner with access to the profile. The physician (i.e., investigator) can provide information about a clinical capacity linked to a disease at the research center, and the server stores the information in a center profile for the research center. The server can display the profile to a trial planner. The profile can include a link (e.g., a web page hyperlink) that causes the display of a center profile for the research center.

In other aspects, the invention provides a system for compiling a network of historical collaborations in which a server device is operable to retrieve a plurality of items, each item indicating a clinical trial in which entities collaborated; identify the entities that collaborated in each clinical trial; and compose, for each entity, a list of clinical trials in which that entity collaborated, the list including the identity of co-collaborating entities. The list can be provided to investigators and trial planners, e.g., as part of a viewable profile. The profiled entities may be investigators, clinical research centers, other personnel or institutions, or a combination thereof.

Aspects of the invention provide a system to retrieve items that indicate a competency to perform a clinical trial and to identify an investigator name within the items, along with a title. The system composes a list of the titles for each investigator and can allow the investigator to access the list (e.g., to edit it). In some embodiments, the items are digital records of publications and the titles are the titles of the publications. In certain embodiments, the items are clinical trials. Preferably, each item is mined (e.g., using regular expressions) for the names of other entities (investigators or research centers) and the finding of an additional entity in the item is used to establish a network connection between the investigator and the additional entity. The items may be retrieved from an online library database, a database of clinical trials, or a similar source. The network can be built and refined by allowing the investigator to edit the list. The list may be displayed on a profile web page.

In related aspects, the invention provides a method for compiling a list of clinical trial credentials by retrieving over a communications network a plurality of items, each item indicating a competency to perform a clinical trial and executing computer program instructions to identify an entity name within each item. For each entity, a list of competencies is composed. The entities an be researchers or research institutions. In some embodiments, each item comprises a web page of a research center, each entity comprises a research center, and each competency comprises a clinical procedure. In related embodiments, each item includes a web page of a research center, each entity comprises a researcher, and each competency comprises a clinical procedure. Where the entities include a plurality of researchers, the person may be one of the plurality of researchers. To build, refine, and strengthen the underlying network, a profiled person is allowed to link their profile to profiles of other entities. To further improve the network, the other entities may be allowed to confirm the links.

In some aspects, the invention provides computer systems for compiling a network of historical collaborations. Systems include a computer operable to retrieve a plurality of items that each relate to a clinical trial in which entities collaborated and identify the entities that collaborated in each clinical trial. The computer may then compose, for each entity, a list of clinical trials in which that entity collaborated, the list including the identity of co-collaborating entities, and provide the list for access by the entity. Those entities may be investigators, sponsors, research centers, or any other relevant entity, and may be identified using regular expressions. The composed list may be provided to a person to allow that person to edit or update the list before it is further used in systems and methods of the invention.

Further, the invention provides methods of compiling a network of collaborations. Methods include using a computer for retrieving over a communications network a plurality of items, each item indicating a clinical trial in which entities collaborated; executing computer program instructions to identify the entities that collaborated in each clinical trial; composing, for each entity, a list of clinical trials in which that entity collaborated, the list including the identity of co-collaborating entities; and providing the list for access by the entity.

In certain aspects, the invention provides a system for compiling a list of clinical trial credentials. Systems include a computer operable to retrieve, over a communications network, a plurality of items, each item indicating a competency to perform a clinical trial. From within the retrieved items, investigator names, titles, or similar pieces of information are identified by a computer program. For an investigator name, the computer program composes a list of associated titles and saves the list in the memory. The computer can then provide the list for access by the investigator. The listed items may be publications (e.g., journal articles), clinical trials, or both. Lists of items can be retrieved from online databases or library catalogs. Investigator names, titles, and other information can be pulled out of the retrieved information using computer programming techniques such as regular expressions. The computer may then allow the investigator to edit the list and subsequently displaying the list on a profile web page.

In a related aspect, the invention provides methods for compiling a list of clinical trial credentials in which a computer is used for retrieving over a communications network a plurality of items, each item indicating a competency to perform a clinical trial and executing computer program instructions to identify an investigator name within the items and a title. For the investigator name, a list of associated titles is composed and saved in memory and the list is provided to the investigator, who may then optionally edit, contribute to, or update the list before it is released for public access.

### BRIEF DESCRIPTION OF THE DRAWINGS

FIG. 1 shows a display of locations where clinical trial centers are located.

FIG. 2 shows a screen through which to access a center profile.

FIG. 3 shows a part of a center profile according to certain embodiments.

FIG. 4 shows a home screen for viewing a network.

FIG. 5 shows an exemplary screen for editing a network.

FIG. 6 shows a screen for inviting an entity to join a network.

FIG. 7 shows an exemplary computer systems according to certain embodiments.

FIG. 8 shows elements corresponding to 13 of the 19 hypertensions research facilities in Paris, France, according to the invention.

FIG. 9 illustrates a search for viral hepatitis research facilities in Saudi Arabia according to the invention.

FIG. 10 shows a list of 8 viral hepatitis research facilities in Saudi Arabia according to the invention.

FIG. 11 shows a breast cancer profile of The Saudi Institute according to the invention.

FIG. 12 shows a breast cancer profile of Smith Research according to the invention.

FIG. 13 illustrates browsing the trials and publications related to breast cancer from the Saudi Institute according to the invention.

FIG. 14 shows a display of elements corresponding to groups of viral hepatitis research entities with propensity of trial acceptance set as a criteria according to the invention.

FIG. 15 shows a display of elements corresponding to groups of viral hepatitis research entities and a menu for supplying more criteria according to the invention.

FIG. 16 illustrates searching for groups viral hepatitis research centers with available patients according to the invention.

FIG. 17 shows a sub-group of viral hepatitis research entities in Singapore comprising 53 research centers according to the invention.

FIG. 18 shows several subgroups of HIV research centers in Argentina, with elements sized to indicate a number of research centers in each subgroup, according to the invention.

FIG. 19 shows a sub-group comprising eight HIV research centers in Buenos Aires according to the invention.

### DETAILED DESCRIPTION

The invention provides systems and methods by which a clinical trial planner can evaluate clinical research centers for participation in a prospective clinical trial. Further, the invention also provides systems and methods for disease-specific marketing and evaluation of clinical research centers using tools for viewing and analyzing a global network of clinical research centers by general and disease-specific parameters relating to regulatory environments, candidate patient populations, and clinical capacities as well as center and investigator competencies as demonstrated through factors such as past trials, publications, and collaborative abilities. For clinical research centers, the invention provides systems and methods for collecting and editing information about the capabilities of the center in general, as well as disease-specific capabilities, through both automated import tools and user interface editing tools, as will be discussed in greater detail herein.

For the trial planner, the invention generally provides tools for site selection during the planning of a clinical trial. Using tools of the invention, a trial planner can view lists of research centers or information about individual research centers to assist in identifying those centers that are viable candidates for inclusion in the planned trial. Further, the invention provides tools by which a trial planner can, having in mind one or more criteria for participating centers in which those criteria are general or disease-specific, identify centers that satisfy the planner's criteria.

Compared to prior art approaches that required paper-based feasibility questionnaires, the invention provides a system for applying criteria relevant to a prospective clinical trial to the universe of research centers to identify those centers that pre-qualify for participating in a study.

The invention includes the recognition that at present and in recent years, an ever-increasing percentage of clinical trials are multi-site, multi-national trials and that existing feasibility-questionnaire-based approaches to trail planning not only require very large amounts of money to be spent to plan a trial—thus keeping smaller firms from sponsoring studies and bringing new drugs to market—but also consume large amounts of time, delaying the entry of life-saving drugs to market. Systems and methods of the invention are provided to reduce cost and time, while increasing the quality of trial plans coming out of the trial planning process. The invention includes the recognition that significant barriers exist to effective trial planning in the form of uncertainty about foreign and international regulatory approval processes. For example, where a firm in the Americas or Europe may seek to plan and sponsor a trial for a new drug, there may be uncertainty about applicable rules and regulations in China, Taiwan, Korea, Indonesia, Hong Kong, Singapore, or India. Tools of the invention aid sponsors in establishing and building productive relationships with contract research organizations (CRO)s or centers in various international markets. In some embodiments, tools of the invention allow a trial planner to analyze and evaluate centers according to specific criteria, capacities, performance indicators, benchmarks, or intrinsic or extrinsic aspects of the center and its location Clinical trials are discussed in Potter, et al., Site selection in community-based clinical trials for substance abuse disorders: strategies for effective site selection, Am J Drug Alc Abuse 37:400-407 (2011); Ng, R., Drugs From Discovery to Approval, 2d Ed, 2000, John Wiley & Sons, Hoboken, N.J., 466 pages; Chung, et al., A guide on organizing a multicenter clinical trial: the WRIST study group, Plast Reconstr Surg 126(2):515-523; and Rohrig, et al., Sample size calculations in clinical trials, Dtsch Arztebl Int 107(31-32):552-556 (2010), the contents of each of which are incorporated by reference herein in their entirety for all purposes.

In certain embodiments, the invention provides a database of centers including information about each one and tools for querying the database across axes that include general information as well as disease-specific information. Individual centers can be evaluated by accessing and viewing a center profile. Center profiles can include detailed information about: clinical capacity; location; available patient population; investigators working at, or available to work at, the site, to name but a few examples. Moreover, one hallmark of embodiments of the invention is the ability to present subsets of the total profile of information organized by disease.

Within a disease-specific profile, a trial planner can view numerous specific pieces of information relevant to that center's capacity to participate in a clinical trial. For example, a planner may wish to plan a trial that includes 500 patients representing individuals of both Asian and European ancestry. The trial planner may wish to use centers that are in jurisdictions with regulatory fast tracks and in which clinical trial preparatory stages can run simultaneously (e.g., regulatory approval and patient recruitment) and not sequentially. The trial planner may need a certain percentage of the patients to have a disease such as, for example, lung cancer. Finally, the trial planner may wish to only include centers with the capacity to perform the tumor M2-PK EDTA plasma test, the serum carcinoembryonic antigen (CEA) test, and the tissue inhibitors of matrix metalloproteinases-1 (TIMP-1) test.

Using tools of the invention, the trial planner can input those parameters and receive a list of centers. The trial planner can then view a profile for each center to further evaluate the center for possible inclusion in the study.

In some embodiments, a trial planner may need to ascertain some fact about the centers that is not already included in their profiles. Tools of the invention can accept a question from the planner (e.g., “Do you have next generation sequencing (NGS) hardware?”) and relay it to center personnel. Answers may be integrated into the knowledge base to be queryable in subsequent uses of systems of the invention. Thus, the invention allows a trial planner to drive the development of the underlying knowledge base by proposing new questions for inclusion into the data gathered from center personnel (which is discussed in greater detail below).

Further, while systems of the invention can provide and display lists or groups of qualifying centers and profiles of individual centers, including profiles that are composed to represent the capacities of the center in general, as well as the capacities of the center as regards a specific disease, the invention also provides tools for provision of profiles of individual investigators working in connection with the centers. As discussed below, the invention includes tools and mechanisms by which individuals can contribute to or edit their profiles, including mechanism for pre-populating profiles automatically and allowing individuals to confirm or edit the pre-populated content.

In certain aspects, the invention provides novel tools for the display of global networks of research centers to provide a valuable, powerful, and intuitive visualization of research center capacity.

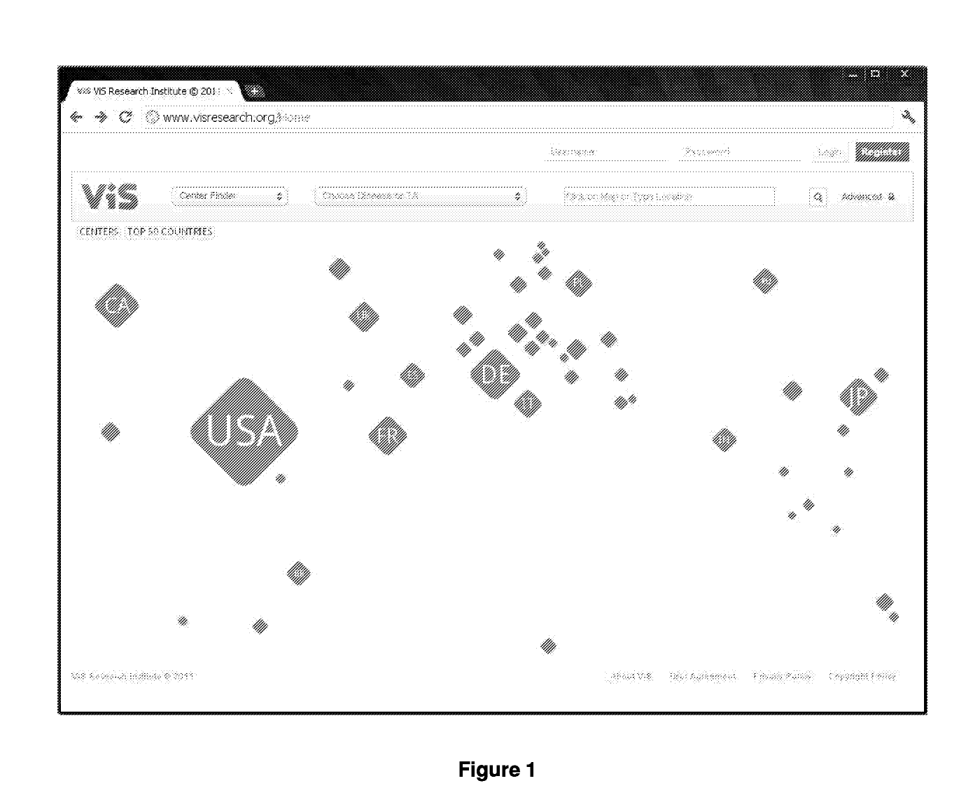

FIG. 1 shows a display of locations where clinical trial centers are located according to certain embodiments of the invention. The invention provides visual information systems functionally linked to profiles and sets of profiles. Information relevant to centers is delivered as a dynamic visual display, which can receive interaction from a user in the form of touchscreen, keyboard, or mouse gestures while composing a profile of a research center, or a group of research centers, or a map-view of research locations, in response to that interaction. For example, as a user types “P”, then “a”, a display will offer “Palo Alto,” “Paris,” and similarly-named places. When the user chooses one, the screen displays research locations from those places in a map-view. A research location can include a research center, or a geographic location of one or more research centers. Map views of the invention are functionally linked to profile information. A user can position a particular map view on-screen, and further specify a disease. The display screen can adjust the links to profiles of research centers within the present map-view that have performed a clinical trial relevant to that disease. If a user changes the disease to a second disease, the display can change in functional response to the user's input, displaying links to profiles of research centers that have performed clinical trials relevant to the second disease.

Thus, systems of the invention provide valuable tools for the evaluation of research centers for inclusion in particular clinical trials. In certain embodiments, the invention offers a multi-axis system for clustering research centers. The system can include one or more of: an axis for geographic location; an axis for disease; an axis for extrinsic characteristics; and an axis for an intrinsic characteristic. Each research center can optionally have at least one value along each axis. A user can select values along N different axes (e.g., Asia, autism, available population of subjects under age 14, publication in a journal with impact factor >25, indirect costs <30th percentile). It should be noted that the disease selection can further optionally define additional axes in combination with primary axes. Thus systems of the invention can combine autism with publication to query for “publications on autism in a journal with impact factor >25”. The selection of values (along with an optional plus/minus range) defines an N-dimensional space including certain research centers. Systems of the invention can collocate information relevant to those centers and optionally the chosen disease and other axis values, and use the collocated information to compose—for example in response to a user interaction—a profile for each of one or more of those research centers. The profiles can be displayed in relation to how the user interacts with the system. The profiles can optionally be stored (e.g., for later viewing or downloading, optionally in connection with a user's login or account). Sets of research centers can be defined by a particular defined N-dimensional space, and those sets can comprise geo-graphically segregated subsets. A set can be offered to the user, e.g., for display in the interactive visual system of the invention, or as a list or similar data file, or can be offered for sale to the user, to be provided in a display or file.

Systems of the invention include a database accessible through client devices over internet connections. The invention provides tools for meaningful review and use of the data. In some embodiments, the invention provides HTML5 based interaction tools. The invention further provides advanced search algorithms to enable a user to find research centers that can fulfill trial-specific needs. The user may, for instance, filter the center search by disease, location, local cost per patient, local availability of specific comparator drug, local acceptance of placebo-control, size of local patient sub population, or availability of a certain diagnostic tool or expertise in the research center. The invention provides tools for screening research centers, or including them in result sets, based on criteria including aspects related to: research personnel, patient population, research infrastructure, cost, research activity, regulatory environment, publication history, peer reviews or ratings, or expertise areas.

The invention provides tools for maintaining, composing, rendering, and displaying profiles of research centers and further provides for disease-specific profiles, allowing for more than one profile per center. Users can easily move back and forth between analysis of disease-specific capabilities of the centers and global comparisons of locations of interest. The invention provides a live integration whereby information included within a profile component influences live geo-referenced visual displays of research entity information. This aspect of the invention provides research facilities with an incentive to contribute information into profile components, thereby increasing the value of the visual displays to research planners.

The invention provides a user with a research center identity, or a set thereof, which can be defined by an available patient population, the patient population having certain characteristics. By aggregating data from previous trials or other available sources, the invention can provide patient population information which can be used similarly to, but more freely than, patient population gathered through methods that rely on patient-specific or patient-identifying information, as this data includes of information that does not identify individual patients. The invention provides systems and methods to aid trial planners in choosing centers based on available patients, which can be used where use of patient-identifying information is otherwise prohibited. In particular, in combination with the disease-specific modality of the invention, a trial planner can access complex, multi-dimensional data previously unavailable and critical to planning an effective clinical trial.

Furthermore, the invention provides robust tools for the critical evaluation of research centers individually or for the synthesis of groups of research centers according to critical evaluation standards chosen by a user. By including data known by the industry to be indicative of the performance of a research center or of interest to a trial planner, the database can be queried for one or more relevant critical values in one or more relevant metrics (such as, location, cost, the user's prior subjective evaluation, local government's rules (i.e., participate in PCT? Informed consent laws similar to country X? last inspection date?), or center administration (non-profit? Owned by company Y? publically traded on NYSE? Professional staff member-in-good-standing of association?). Thus, a planner of a clinical trial has access to valuable information defining research centers across the globe, allowing the planner to identify and evaluate centers, for example, for potential participation in clinical trials.

The invention provides the ability to offer certain output components free of charge while offering other output components for a fee, thereby deriving revenue from research planners who benefit from the invention. Methods and systems of the invention are optimized to collect or aggregate highly specialized human expertise that is very hard to replicate, combined with vast amounts of information and complex algorithms that are tightly protected as trade secrets.

Visualizations

In some aspects, the invention generally relates to systems for displaying information relevant to one or more entities. FIG. 1 is one display according to the invention. In certain embodiments, systems of the invention reference the geo-coordinates of a number of entities. The entities can be, for example, clinical research centers or facilities. The system composes output suitable for display by a client application.

A client application according to the invention can be web browser, and the system can compose HTML5. In some embodiments, the client application is a standalone “app”, for instance, that a user installs onto a device, and the output is proprietary code capable of being interpreted by the app. In other embodiments, the output is flash animation. In some embodiments, the output is a JavaScript command.

In some embodiments, a display is interactive. Possible interaction include: zooming; panning; rotation; and clicking or tapping an element. A display can be rendered on a touch screen device or through any computer monitor including, for example, LCD projectors. On a touch screen device, interactions include pinch-to-zoom or swipe-to-pan or any other gesture-based interactions known in the art. On a computer monitor, interaction can be done through a mouse or other pointing device, and can include, for example, zooming by use of a scroll-wheel, panning by mouse-swipe, and clicking to activate a link. Any such means for receiving client interaction data are included in the invention.

A display according to the invention generally includes one or more elements, shown in FIG. 1 as convex polygons having the form of equilateral diamonds. In certain embodiments, the elements are tessellating figures (e.g., squares, diamonds, hexagons, hexagons and pentagons in about a 20:12 ratio, irregular figures, Escher lizards or other whimsical figures, etc.).

Each element is associated with one set of geo-coordinates. Depending on the level of “zoom”, a set of geo-coordinates can be associated with one entity or a cluster of entities. For example, at a very “zoomed in” level, a display area may correspond to a city or neighborhood, and each entity will have a set of geo-coordinates comprising one latitude-longitude pair. At a more “zoomed out” level, a display area may correspond to a country, and all entities that are in a city may have their geo-coordinates put into a set that corresponds to a single display element. At the most zoomed-out level, for example, each display element may correspond to a nation, and all entities within that nation may be represented by that display element.

In certain embodiments, an aspect of a display element indicates a number of entities associated therewith. As illustrated in FIG. 1, USA is the largest display element and thus includes the most research facilities. Japan (JP) is a mid-sized element, and thus includes an intermediate number of facilities.

To display elements, the invention provides for receiving the associated geo-coordinates (i.e., pulling them from a database, from mapping or GIS program, or receiving them as input) and translating the geo-coordinates into computer-readable code capable of being rendered in a display. For the sake of convenience, since that computer-readable code includes a representation of the relative position of the elements, that code can referred to as translated coordinates. Translated coordinates can refer to information to position an element on a screen and is not limited to a pair of latitude and longitude numbers (although those are included in certain embodiments).

In some embodiments, systems and methods of the invention receive display elements, not as coordinates, per se, but as elements rendered or delivered as displayable data. For example, elements can be present as scalable vector graphics, or can be rendered by a software program or service. In some embodiments, the coordinates of elements take the form of a drawing command issued to an Application Programming Interface (API), and a transformation of those coordinates takes the form of a new command. Systems and methods of the invention can receive information for displaying elements in many formats, including but not limited to: SVG 1.1 (second edition), GPX (a standard format used with many devices and programs, including Garmin's eTrex, GPSMAP, Oregon, Dakota, Colorado, & Nüvi series), Google Earth (.kml/.kmz), Google Maps routes (URLs), Geocaching.com (dm), XML feeds, Garmin Forerunner (.xml/.hst/.tcx), Timex Trainer, OziExplorer, Cetus GPS, PathAway, cotoGPS, CompeGPS, TomTom (.pgl), IGN Rando (.rdn), Suunto X9/X9i (.sdf), and tab-delimited or comma-separated text. The digital form by which displayable elements are delivered to or handled by the invention is described as coordinates for convenience's sake, as it is acknowledged that SVG, etc., can describe elements that are intuitively or satisfactorily analogized to coordinates. In some embodiments, a program (i.e., PHP script) converts among SVG files, geo-coordinates, drawing commands for a JavaScript API, and similar. In some embodiments, elements include objects of types such as GMarker, GIcon, GPolyline, GTileLayerOverlay, GInfoWindow, or similar, which can be interpreted, for example, by a JavaScript API (e.g., version 3 of the maps JavaScript API). In some embodiments, elements are displayed in a standalone app or by tools such as Rails with, for example, an app made with the Rails plug-in Geokit.

While elements are described herein as having coordinates, which can be transformed or adjusted, such descriptions include processes of rendering pixels and, for example, subsequently re-rendering pixels to “overwrite” the first set, or to give the impression of animation. For effective communication, elements are described in terms of coordinates, and adjusting or moving those elements, or displays thereof, can be described as transforming the coordinates. In some embodiments, transforming coordinates involves re-drawing a visual display. In some embodiments, transforming coordinates involves re-issuing a drawing command, causing an API such as a JavaScript API to redraw a screen.

A display element of the invention generally includes an area of a display and therefore includes more than a point. A pair of geo-coordinates generally indicates a point. Accordingly, translation of geo-coordinates according to embodiments of the invention includes creating digital data that describes an area of a display (e.g., a specified plurality of pixels on a monitor). Thus, translated coordinates can be described as a set to the extent that, when a display area is considered as a field of contiguous unit areas (e.g., like pixels on a monitor), translated coordinates encompass a number of the contiguous unit areas (i.e., a set). Thus, a relationship between two sets of translated coordinates can be described according to set language, such as disjoint, intersecting, or subset.

The invention provides systems to optimize the display. Since a display according to the invention can be created for utilitarian applications, such as identifying a global distribution of clinical trial facilities, and since elements of the display themselves may include functional information (numbers, text-labels, informative colors, etc.), systems of the invention can render a display having no overlap or superposition of elements. Furthermore, this creates an aesthetically pleasing display, which can encourage people to use an associated service.

Systems of the invention can create a display of elements wherein no element is super-positioned over another by pairwise comparing each set of translated coordinates. For each pair of sets, if intersection is detected, the system can transform one or each set of the pair. For example, an area of intersection can be determined, the area of intersection defining an x distance and a y distance. Then, each of the pair of sets of coordinates can be transformed by incrementing the coordinates by ±0.5(x) and ±0.5(y) to move the elements away from the intersection. This generates a new set of coordinates, referred to as transformed coordinates for convenience. A set of transformed coordinates according to the invention can have all the same properties as a set of translated coordinates, and systems of the invention can further treat a set of transformed coordinates just as a set of translated coordinates.

Another display optimization provided by systems of the invention is outlier processing. In some embodiments, any group of sets of translated (hereinafter, translated can mean “translated or transformed”) coordinates defines a set of display elements. Any set of display elements defines a centroid. Centroid, generally, refers to “the middle of a cluster” and in certain embodiments can be found by determining an intersection of all straight lines that divide the set of elements into two parts of equal moment. In some embodiments, the invention provides heuristics for determining a centroid, including, for example, determining an average of all x coordinates and an average of all y coordinates, or a harmonic mean of each. Any method of finding or approximating a centroid is useful in the invention.

For any group of translated coordinate sets, one or more of the coordinate sets may be an outlier. Outlier, generally, refers to coordinate set that is numerically distant from the rest of the sets in a group. Specifically, an outlier can be an element that would be drawn on the screen far away from a number of other elements in the same group. To present the elements in a visually useful or pleasing way, systems of the invention can process an outlier so that it is rendered closer to the group in a display than its coordinates would indicate. Outlier processing can involve transforming the coordinates of the outlier (e.g., by reducing a vector magnitude or reducing an x or y value), thereby optimizing the display. In some embodiments, outlier processing can include defining a coordinate field for display with a non-linear scale (e.g., non-linear axes, quasi-log, or similar) so that, for example, a distance of 100 is less than 10 times a distance of 10.

Outlier processing can further involve modifying a visual aspect of a displayed element or a field of display to indicate a true scale of the outlier. For example, the element can be rendered smaller than, or larger than, a proportional rendering would yield (in general, rendering elements according to the invention can include rendering their size to correlate with an associated number, for example, of entities at a location). Another modification of a visual aspect of a display included in outlier processing can be rendering a system of grid lines to appear (e.g., behind) one or more elements, the lines being curved or having non-orthogonal intersections, to indicate a “stretching away” in space, thereby indicating that an individual entity is, in-fact, further from a centroid than it otherwise appears. In certain embodiments, outlier processing involves transforming a set of translated (i.e., translated or already transformed) element coordinates to yield a set of transformed coordinates. Optimization of a display can include multiple optimization steps conducted in any order, in parallel, in combination, or simultaneously. For example, elements could be processed to resolve superposition, outliers could be processed, and elements could be re-processed to further resolve superposition. In some embodiments optimization processes—which can include superposition resolution, outlier processing, or other methodologies—are each conducted by an independent routine, module, or object of computer software, each of which can analyze coordinates independently of another. Generally, translation or optimization will yield a set of coordinates corresponding to elements to be displayed.

The invention provides methods for rendering a display of one or more elements. Elements can represent entities that exist, for example, in the natural world or in a data set corresponding to a world (e.g., a game world or a file showing plans for future buildings). Each element can be positioned within a display (e.g., a screen) according to the relative position of an associated entity. In some embodiments, each element corresponds to a location at which one or more entities are sited and an aspect of each elements indicates a number of entities at the corresponding location. The aspect can be a number displayed within the element, a size of the element, a color of the element (e.g., light gray indicates few, medium gray indicates several, and black indicates many), or a list displayed in or near an element.

The display can be re-rendered to correspond to different levels of magnification (i.e., different levels of zoom). In some embodiments, an element corresponds to a different level of geographic specificity at different levels of zoom. For example, in certain embodiments zoom levels of city (about 1 to 10 miles shown in a line across the display), state (about 25 to 500 miles across display), country (about 1,000 to 5,000 miles across), continent (5 k to 20 k), and globe are associated with elements that, respectively, correspond to individual entities (e.g., facilities or campuses), entities or cities, cities or states (or provinces), states or countries, and states or countries.

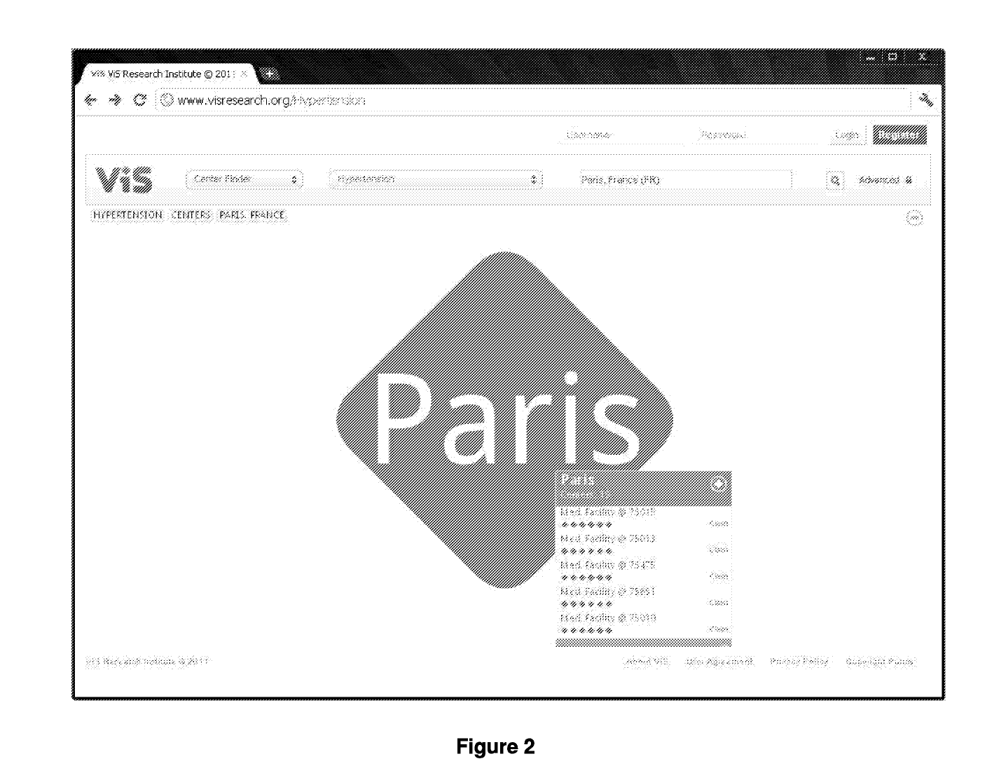

FIG. 2 shows choosing a location and also shows an element corresponding to a group of hypertension research facilities in Paris, France, according to the invention.

An element as rendered in a display can optionally contain links, links to links, other elements, and can be interacted with, re-positioned, and influenced by other elements or information. In some embodiments, systems and methods of the invention generate output capable of being rendered as a visible display. In certain embodiments, output includes HTML5 elements, which can include, for instance, JavaScript commands or HTML5 elements describing each element. An element can be described to have material displayed within, or associated with, it. In some embodiments, an element is rendered in a display to have keyboard characters or an image in it, and that material can optionally be a link, such as an HTML or HTML5 hyperlink, which can operate to send a web browser to another display. In some embodiments, a link causes a pop-up, such as a pop-up window, a pop-up menu, or a pull-down menu, to appear. An element can include a textual or image (i.e., jpg) label to be displayed when it is selected such that the label contains specific information about the location or active links to profiles of entities conducting business in the corresponding locations. FIG. 2 shows a list of hypertension research facilities in Paris, France, according to the invention.

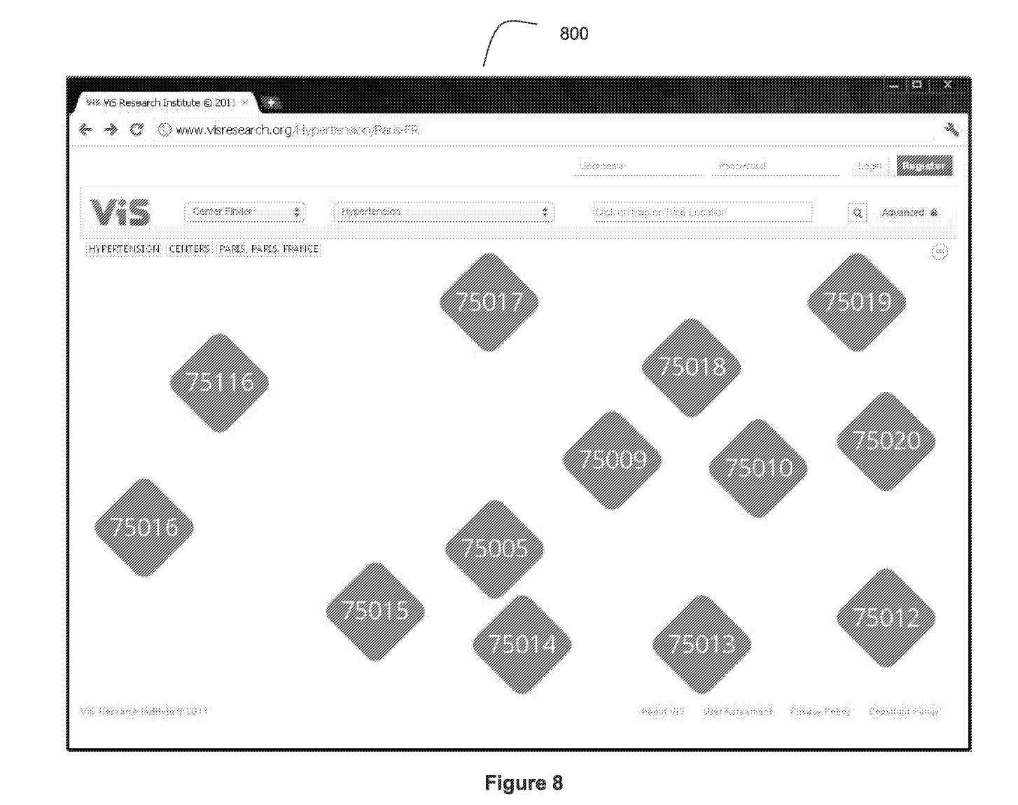

The positioning, size, and other aspects of the displayed elements can dynamically adjusted, for example, to fit a defined space. A display according to the invention can be designed to respond to a user's input. For instance, a display can include map-like elements, and a user can zoom in on certain areas, and systems and methods of the invention can re-render or adjust the rendering of the display to include the results of the user's browsing or zooming. FIG. 8 shows elements corresponding to 13 of the 19 hypertensions research facilities in Paris, France, according to the invention.

In certain embodiments, a user can set or toggle criteria controlling what is displayed, and systems and methods of the invention can respond (e.g., interactively) to show/hide things according to a user's selection of options, criteria, or filters.

A display can be shown so that a user is able to interact with elements (i.e., with the geo-referenced information), for example, through the use of a mouse click or touch on the area of the corresponding polygon. The invention provides display elements capable of being shown or interacted with on a touchscreen or through any other computer monitor.

The present invention provides tools for the display of geo-referenced information on the screen of a computerized system, like a tablet, smartphone, laptop or desktop. The information referenced to each location can be displayed primarily in the form of equilateral convex polygons (e.g. equilateral diamond) that can be, for example, distributed in a HTML5 canvas of adaptable dimensions.

The positions of the polygons can be referenced to the corresponding geo-coordinates of individual locations. Such positions can be dynamically adjusted to fit the space available in the canvas employing mechanisms that detect when a given polygon is superposed with another one, performing corrections though computations of new position combination when that occurs. The sizes of the polygons can be adjusted automatically when necessary to enable the inclusion of all elements inside the electronic canvas. The invention provides a mechanism to detect elements that are far away from the centroid of the visualization and automatically pull them towards mathematically specified positions closer to the other elements.

This web-based visualization system enables the display of multidimensional geo-referenced information by variation of: position of polygons based on latitude and longitude; size of the polygons; color of the polygons; color transparency of the polygons; internal textual label of the polygon; external textual label of the polygon; variations in the width of the line delimiting the polygon; variation in the texture of the filling of the polygon; or any combination thereof. Exemplary tools for display are discussed in U.S. Pub. 2011/0270705, U.S. Pub. 2011/0175923, U.S. Pub. 2011/0185286, U.S. Pub. 2010/0106752, and U.S. Pub. 2007/0174331, each of which is hereby incorporated by reference in its entirety.

A user is able to interact with the geo-referenced information through the use of a mouse click or touch on the area of the corresponding polygon (e.g., touch with mouse pointer or touch with finger on touch screen). Such interaction includes commands to zoom in (into the lower geographic level) or zoom out (to the higher geographic level) from the given geographic location, which can trigger the creation of new visualizations showing the new elements in the chosen geographic level.

An external textual label can appear when the polygon is selected, and can contain specific information about the location, active links to profiles of the entities conducting business in the corresponding locations, or both.

Methods of displaying networks as polygons or similar on-screen icons, based on geo-referenced coordinates associated with the centers or their locations, have been disclosed in the related application U.S. Provisional Patent Application No. 61/569,098, COMPARATIVE EVALUATION AND MARKETING OF RESEARCH ENTITIES, filed on Dec. 9, 2011, the contents of which are hereby incorporated by reference in their entirety.

Dynamic, Disease-Specific Content

In embodiments of the invention, relevant networks are displayed based on trial experience, team expertise, patient population, infrastructure, publication record, and degree of global interconnectivity of a research team (not only one person) of participating centers. One concept of the invention is that one or more of these factors can be used to develop a center's representation in the display. For example, where a trial planner inputs criteria for centers, they may explicitly use definitions or criteria that limit the inclusion of centers into the display that they see. For example, a trial planner may require that a center has participated in at least one prior clinical trial relating to a disease for inclusion in their present search.

However, in some embodiments, one or a combination of factors is used “behind the scenes” to develop a centers' inclusion in a trial planner's search results. For example, in an attempt to aid a trial planner in discovering the most competent, relevant centers, where a given location is associated with a large number of search results, those search results can be ordered according to an optionally weighted combination of factors. To illustrate, it may be recognized that a prior history of collaborating in multi-site trials is an important indicator of competency to participate in future multi-site trials. Further, it may be recognized that those centers which have recently taken an active role in updating their profile content (as discussed in greater detail below) also tend to be the centers that participate most constructively in present trials. Accordingly, where a trial planner searches a given location for centers to participate in a trial relating to a specific disease, systems of the invention can recover all N centers in that location with competencies relevant to that disease, and can present them order 1, 2, . . . , N according to a combination of the number of multi-site trials in which the center has participated and the time since the center has last updated its profile, each optionally multiplied by a weighting factor.

Preferably, a database of the invention includes many research centers (e.g., more than 100 and preferably more than 1,000). In some embodiments, thousands of different research centers are included, distributed across many nations, jurisdictions, or geographical regions (e.g., dozens or more than one hundred different nations may be included).

Moreover, due to the ability of centers to update their profiles with ease, a center profile can be offered that is current, to the hour and minute. Where prior art paper-based methods required days, weeks, or longer for information to travel from trial planner to center (in the form of feasibility questionnaire) and back, and would only include that information which either party thought to include at the relevant time, the present invention provides a profile based on contents that includes all information gathered or input by centers. The profile can be as current as the last edit. Further, in some embodiments, the invention provides tools to update the trial planner as relevant information changes. For example, a trial planner may require only centers with helicopter landing facilities and a working MRI. A center that had appeared in a trial planner's pre-qualified list may update its profile to indicate that its MRI system is out of service, and the trial planner's list can be updated to reflect that fact. In some embodiments, a notification can be sent to the trial planner. In similar fashion, if a center that otherwise qualifies and has an MRI facility, but no helipad, completes construction of a helipad and so updates their profile, that center can be added to the trial planner's list.

By such means, a trial planner can analyze and evaluate a global network of clinical research centers according to general and disease-specific parameters updated as medicine's state-of-the-art and commonly used trial protocols (or comparative treatments) evolve.

Aspects of information about research centers include information relating to: regulatory environments; candidate patient populations; and clinical capacities as well as trial-specific center and investigator competencies. For example, center profiles may contain information relating to the availability of a regulatory fast track in the controlling jurisdiction, or estimates on times typically involved in obtaining regulatory approval such as, for example, acceptance by a local agency that proposed trials meet with local good clinical practice (GCP) requirements.

Before turning to center and investigator trial competencies, disease specific capacities of centers are discussed. While a number of specific exemplary capacities, organized by disease, are listed herein below, that listing is not limiting. Rather it illustrates an exemplary embodiment. Centers may provide information about particular hardware, lab equipment, medicines, or other infrastructure that they possess as it relates to a disease. Any single item can be cross-listed under more than one disease in some embodiments (e.g., x-ray machine can be listed under broken bone treatment, dental, and lung disease). A disease can be included in a center profile having no items listed under it (e.g., where a center intends to indicate an availability to participate in a type of trial without having any specialized equipment). In some embodiments, centers or individuals can propose new, or not yet listed, diseases or conditions for inclusion in the database going forward. In certain embodiments, profiles include one or more specific clinical capacities that are shown within a user-selected category that may be selected from adult cognitive disorder; Alzheimer's; arrhythmia; breast cancer; cerebrovascular disorder; CNS infection; diabetes; dyslipidemia; hematologic cancer; HIV infection; hypertension; influenza; ischemic heart disease; lung cancer; mood disorder; pneumonia; prostate cancer; schizophrenia; viral hepatitis; another disease; or any combination thereof.

In certain embodiments, capacities of the centers are organized according to the local availability of drugs or treatments used as comparators in clinical trials of specific diseases. For example, a global trial might need to use a certain type of β-lactam antibiotic or selective-serotonin reuptake inhibitor for comparisons with the drug to be tested. That drug needs to be commercially available locally so that it can be used as a comparator treatment. Considering that a given drug might be available in some countries but not in others, it is important to be able to search for the centers that happen to operate in locations where the comparator drug planned for the trial is available.

In certain aspects, information about centers includes anonymized information about available patient populations. One aspect of the invention is that patient information is aggregated statistical and demographic information, and does not include any information identifying individual patients. Thus a trial planner can query for centers that have historical or present access to patient populations that will satisfy the planner's proposed study. By not including information identifying individual patients, a tool of much greater general availability is offered in that participants can use systems and methods of the invention without invoking strict patient confidentiality laws such as provisions of the Health Insurance Portability and Accountability Act in the United States or similar provisions in other jurisdictions, thereby providing good access to a tool of general value and applicability to the work of trial planners. Searching centers by patient population is discussed in the related application U.S. Provisional Patent Application No. 61/569,098, COMPARATIVE EVALUATION AND MARKETING OF RESEARCH ENTITIES, filed on Dec. 9, 2011, the contents of which are hereby incorporated by reference in their entirety.

Group Composition

In some aspects, the invention generally relates to a system for composing a group of research entities. Systems of the invention provide queryable general information and disease-specific information pertinent to center and investigator competencies as demonstrated through factors such as past or ongoing clinical trials, publications, collaborations, and networks.

The invention generally includes a database of research entities and receiving one or more criteria input by a user (as described above). Systems and methods of the invention can determine that information items in the database satisfy the criteria (as discussed above), thereby identifying a set of research entities satisfying the user's search criteria. In some embodiments, the resulting set will be a subset of all research entities in the database. For example, if the database included three research entities, systems and methods of the invention could identify a set of two research entities that matched certain criteria. In general, the invention provides the ability to identify a commercially or scientifically relevant set of research centers, such as a set that is optimized to perform a clinical research project.

Once a set of research centers is identified, the identities of those centers are written into a file (a file can be a set of related files, such as a first file that identifies the file names and paths of a number of other specific files). A file can be a digital file, for example, stored on a hard drive, SSD, CD, or other tangible storage medium. A file can have an existence as an attachment in someone's email (i.e., existing as IPv4 packets or IPv6 packets or similar) or as an internet transmission (e.g., as packets being sent from a server to a client, for example, through a Network Interface Card, modem, wireless card, or similar, on the server), although a file according to the invention is capable of being written to tangible storage medium.

Writing a file according to the invention involves transforming a tangible, non-transitory computer-readable medium, for example, by adding, removing, or rearranging particles (e.g., with a net charge or dipole moment) into patterns of magnetization by read/write heads, the patterns then representing new collocations of information desired by, and useful to, the user. In some embodiments, writing involves a physical transformation of material in tangible, non-transitory computer readable media with certain optical properties so that optical read/write devices can then read the new and useful collocation of information (e.g., burning a CD-ROM). In some embodiments, writing a file includes using flash memory such as NAND flash memory and storing information in an array of memory cells made from floating-gate transistors. Methods of writing a file are well-known in the art and, for example, can be invoked by a save command from software or a write command from a programming language. Systems and methods of the invention can include programming language known in the art, including, without limitation, C, C++, Perl, Java, ActiveX, HTML5, Visual Basic, or JavaScript.

In some embodiments, a user interacts with a visual interface and puts in criteria, which are received by the invention and used to generate a list of research entities. The list is sent to a web browser, file, or app on the user's device, for instance as HTML5, where it is rendered into a visible display. The user then interacts with the list, resulting in the set of research entities being written to file. User interactions that cause the set to be written to a file include clicking a button (“order now”), or right-clicking and choosing a command (download . . . ), or confirming through a dialog box an intention to save the list. Systems and methods of the invention can thereby write a file comprising a group comprising the identity of the first research entity and the identity of the second the research entity.

The invention provides an online interactive search system for clinical research centers, allowing the user to chose sets of filters relevant to a center selection process.

The criteria are chosen through the use of: active location info text dialog in which user can key in the name of any country, state, city and postal code in the world; a dialog for choice of disease of interest; dialogs for choice of any type of extrinsic (location-specific) characteristics of clinical research centers; dialogs for choice of any type of intrinsic (center-specific) characteristics of clinical research centers.

Systems and methods of the invention provide forms of output for making the set of entities available to a user.

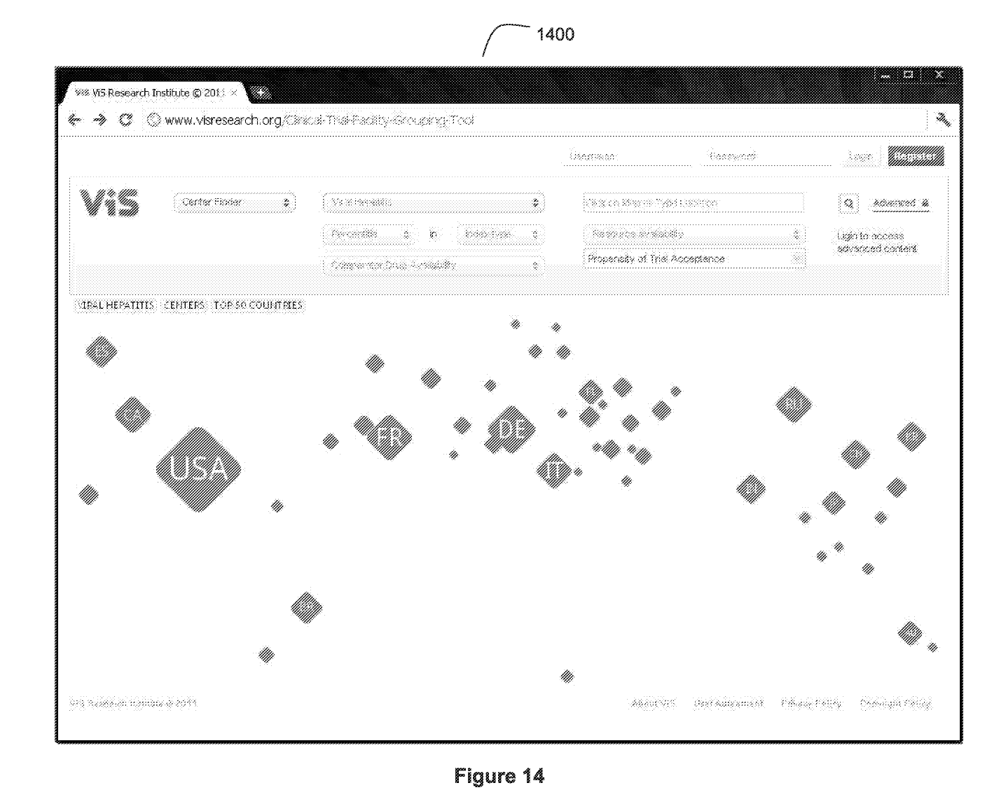

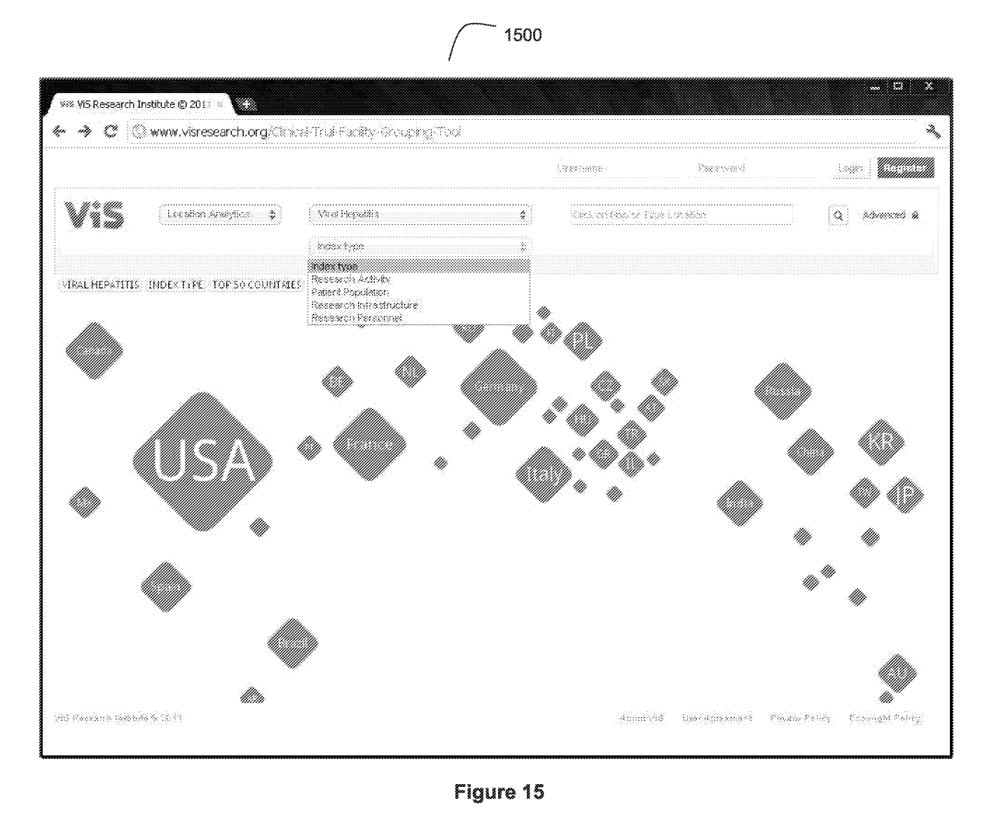

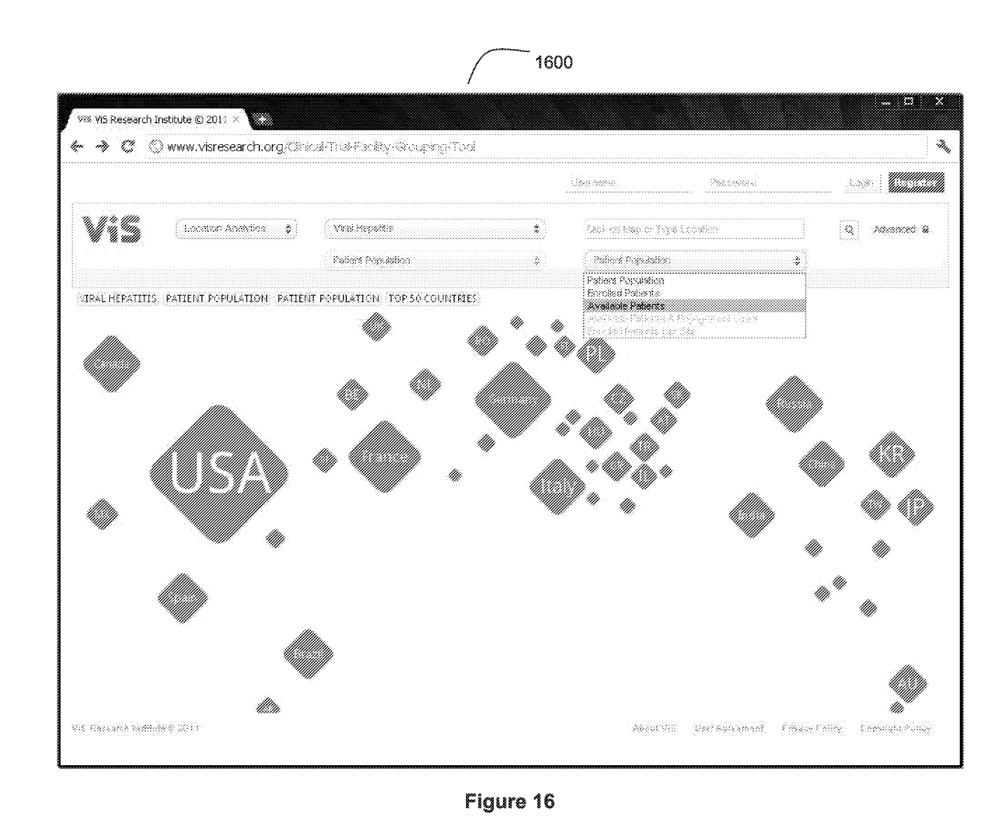

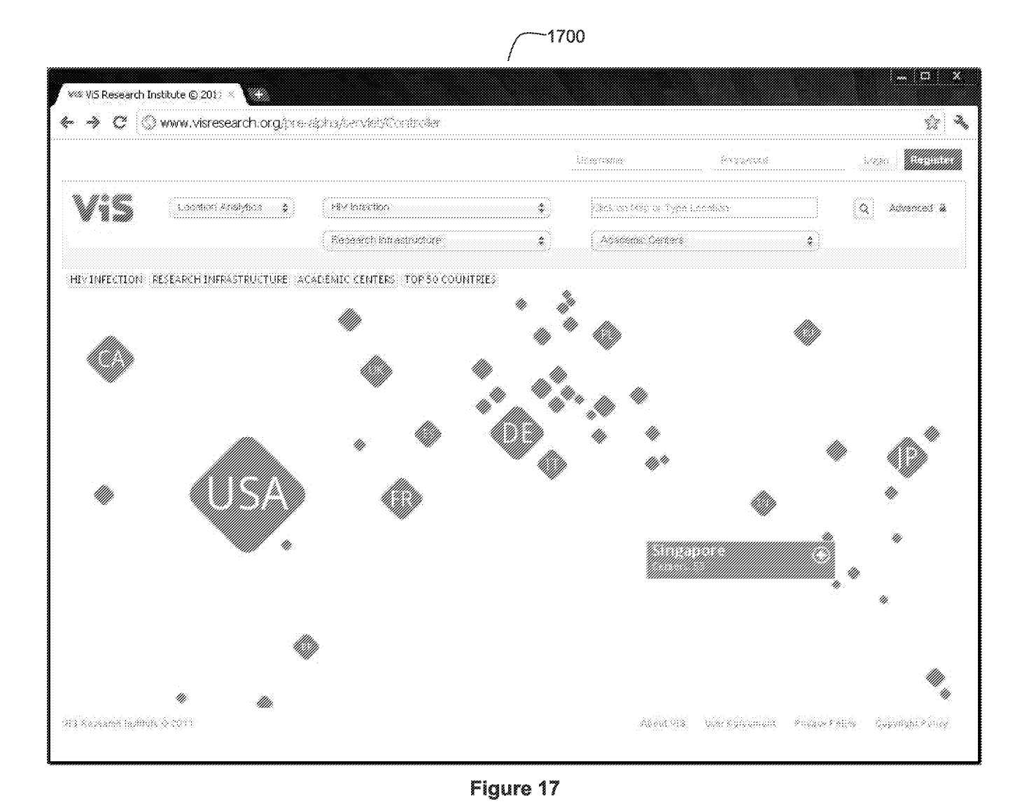

One form of output includes an interactive visualization tool (described above) that dynamically shows the number of centers matching the chosen criteria in each global location though sizes of geo-referenced convex geometric forms, such as equilateral diamonds, in an electronic canvas. Lists of centers in each location can be shown in fields that appear when the respective location icon is chosen. The lists of centers can be clickable links that lead to the respective profiles of research centers containing information about their intrinsic capabilities. FIG. 14 shows a display of elements corresponding to groups of viral hepatitis research entities with propensity of trial acceptance set as a criterion according to the invention. FIG. 15 shows a display of elements corresponding to groups of viral hepatitis research entities and a menu for supplying more criteria according to the invention. FIG. 16 illustrates searching for groups viral hepatitis research centers with available patients according to the invention. FIG. 17 shows a sub-group of viral hepatitis research entities in Singapore comprising 52 research centers according to the invention.

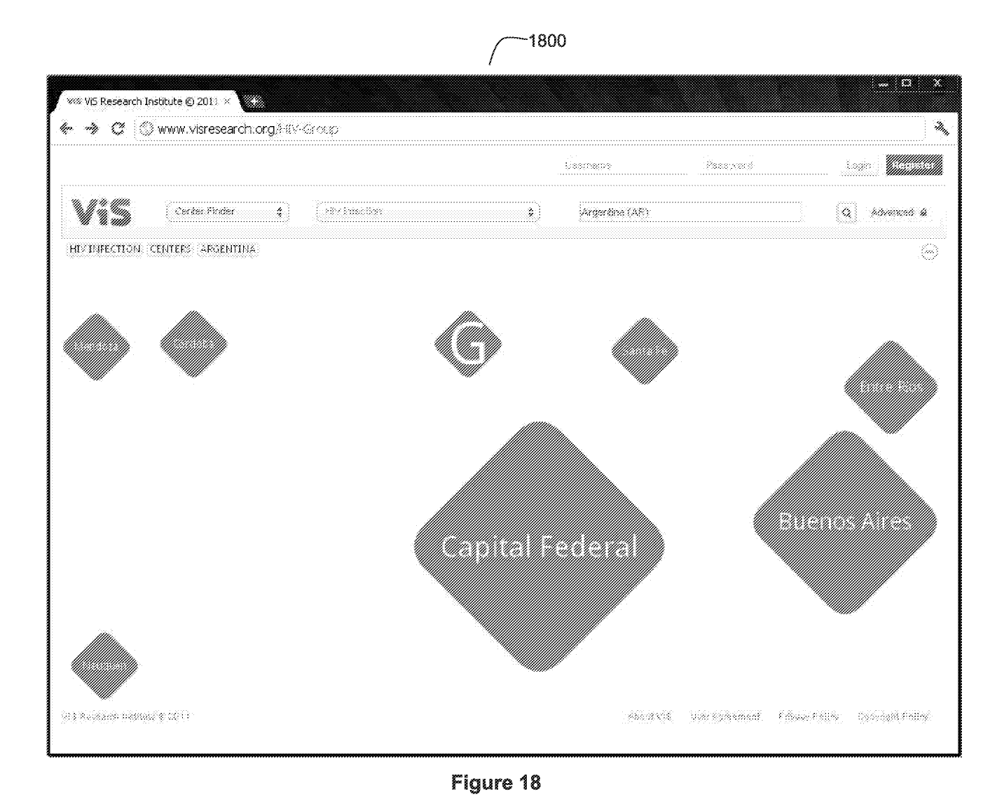

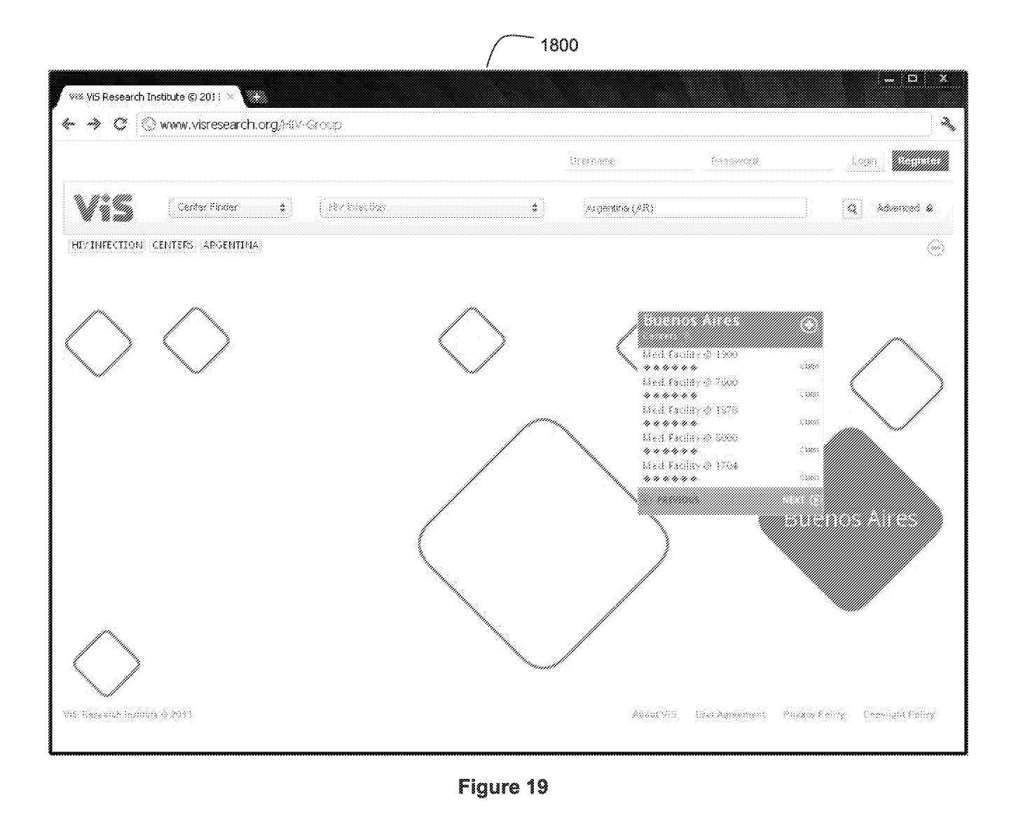

Another form of output includes lists of centers, which can be segregated by their respective locations. The lists of centers can be clickable links that lead to the respective profiles of research centers containing information about their intrinsic capabilities. The invention includes methods for transitioning between forms of output. FIG. 18 shows several subgroups of HIV research centers in Argentina, with elements sized to indicate a number of research centers in each subgroup, according to the invention. A user may click on Buenos Aires to begin invoking another form of output. FIG. 19 shows a sub-group comprising eight HIV research centers in Buenos Aires according to the invention. The list field shown in FIG. 19 can be shown in a variety ways. A list can be shown in a window with a button to expand or maximize it. Clicking on a diamond or similar element can transition screens to a text-based screen showing a list or a set of lists (e.g., geographically segregated).

In one format, where the output can be a group of research entities, the invention provides a dynamic, interactive display of one or more elements. Each element can indicate a number of research entities matching the user's criteria and a location indicated by the position of that element. The number of research entities can be indicated for example, by the size of the element. The elements can be a convex polygon such as an equilateral diamond. Each element corresponds to a local sub-group of the group of research entities. Each element can further display, or interaction with the element can lead to the display of, a list including the local sub-group of research entities.

In a second format, the invention provides output in the format of a group of research entities (e.g., as a list), segregated into sub-groups (e.g., shorter lists) by the locations of the entities.

In both formats of outputs, the lists of entities can include a clickable link for each of the entities (or some of the entities), such that the link leads to a profile, for that entity, containing information about their intrinsic capabilities.

The generation of the output can be controlled by the interposition of an e-commerce interface that releases the information upon acceptance of an acceptable form of payment, including charging to pre-registered credit cards, charge accounts or subscriptions. Users from the same institution may have shared accounts (e.g., corporate accounts) under which the output generated can be saved and entity profiles of interest can be bookmarked.

In some embodiments, the generation of the output can be controlled by the interposition of an e-commerce interface that releases the information upon acceptance of an acceptable form of payment, including charging to pre-registered credit cards, charge accounts or subscriptions. Users from the same institution may have shared accounts (such as corporate accounts) under which the output generated can be saved and center profiles of interest can be bookmarked for posterior viewing. Exemplary methods for processing payments are discussed in U.S. Pat. No. 7,356,502, U.S. Pat. No. 7,542,943, U.S. Pat. No. 7,818,251, U.S. Pub. 2004/0210521, U.S. Pub. 2002/0032648, U.S. Pub. 2005/0192901, U.S. Pub. 2010/0100467, each of which is herein incorporated by reference in its entirety.

By including information about clinical trials in the knowledge base, competencies of the centers can be shown for evaluation by showing a center's real and relevant experience. Including such information further provides valuable tools for sorting and ordering search results. In certain embodiments, past or present clinical trials are stored or tracked in a database of the invention. The participation of individual centers in these trials is tracked in association with the trials. Information about clinical trials can be obtained, for example, from online databases of clinical trials. See, e.g., Ross, et al., Trial publication after registration in clinicaltrials.gov: a cross-sectional analysis, PLoS Med 6(9):e1000144 (2009). For more discussion of clinical trials databases, see generally DeAngelis C D, et al., Clinical trial registration: a statement from the International Committee of Medical Journal Editors, JAMA 292:1363-1364 (2004); Zarin D A, et al., Trial Registration at Clinicaltrials.gov between May and October 2005, N Engl J Med 353:2779-2787 (2005); Lexchin J, et al., Pharmaceutical industry sponsorship and research outcome and quality: systematic review, BMJ 326:1167-1170 (2003); and Zarin D A, et al., Issues in the registration of clinical trials, JAMA 297:2112-2120 (2007).

Databases of the invention can include information about past trials, ongoing trials, planned trials, or a combination thereof. By including information about clinical trials, databases of the invention can include information about research centers that participate in those trials. By including information about research centers that participate in given trials, the invention includes tools for identifying centers that have collaborated in clinical trials (here, optionally meaning centers that have at least both participated in one clinical trial). Further, by including trials in databases of the invention, the databases can include information identifying investigators who have participated in those trials. This provides, for example, one possible source of information by which systems and methods of the invention can automatically pre-populate a database of investigators, discussed in more detail below.

In some embodiments, trial planners can view trials stored in the databases by viewing a center profile and choosing to view a “trials” section, which can show a list of trials that included that center. In some embodiments, a trial planner may view a trial database directly, for example, as a way to begin thinking about how to approach planning a particular study. Further, a trials database provides a ready source of links to provisionally prequalified centers by showing to a trial planner lists of other centers that have participated in a given trial.

In some embodiments, the importance of a trials database lies in how the information is used in sorting and presenting the results of a trial planner's database queries. As discussed above, participation in recent clinical trials can be used to weight the relative position of a center on a list of results.

In certain aspects, the invention includes a database of investigators. Systems and methods of the invention can use information obtained from a database of clinical trials to pre-populate, or contribute to, a database of investigators. Investigators themselves may “log in” and edit, contribute to, or update their profiles. Investigator profiles provide a valuable tool by which trial planners can evaluate centers for inclusion in a trial. For example, the availability of a highly qualified investigator at a given center can indicate the potential value of that center for inclusion. That is, the roster of investigators associated with a center can be used as an indicator of a competency of that center. A trial planner can view the profile of any investigator, including previous trials the investigator has participated in as well as publications of that investigator and other centers where that investigator has worked.

In certain aspects, the invention provides systems and methods for showing a publication history of an investigator associated with a center. In particular, the invention provides for disease-specific viewing of publication histories, in which those publication histories can be collected automatically or provided through the efforts of investigators or center personnel. Publication lists can be provided as a tool for a trial planner to ascertain the relevant experience of a center or investigator. Publications can also aid in automatically identifying historical collaborations among investigators, thereby being used within systems and methods of the invention in building networks.

In certain aspects, the invention provides networks that include investigators or centers and relationships among them. A network can be a set of relationships explicitly disclosed, for example, through an investigator or center's profile. A network can also be used “behind the scenes” by tools of the invention to leverage relationships among participants to provide information to trial planners identifying centers or investigators relevant to a prospective clinical trial. Use of a network feature according to embodiments of the invention allows trial planners to easily see centers that are connected and that share similar features or operating protocols, which can aid the trial planner in further identifying more potential centers for inclusion in a study.

As discussed herein, above, and in U.S. Provisional Patent Application No. 61/569,098, COMPARATIVE EVALUATION AND MARKETING OF RESEARCH ENTITIES, filed on Dec. 9, 2011, the contents of which are hereby incorporated by reference in their entirety, the invention provides valuable tools for the clinical trial planner to use in planning a clinical trial. The tool includes a database of information pertaining to clinical research centers and an application server operable to compose research center profiles and display those to trial planners.

Systems and methods of the invention further include tools for gathering data for research center profiles through automated internet information retrieval and through interface tools for operating by personnel from research centers. From the point of view of research center personnel, the invention provides tools for collecting and distributing information about capacities, both general and disease specific, of a research center to participate in clinical trials. Accordingly, the invention provides valuable marketing tools for research center personnel.

In some embodiments, the invention provides tools for clinical research center marketing through the capture of general and disease-specific analytics that can be automatically updated as medicine's state-of-the-art and commonly used trial protocols (or comparative treatments) evolve. Systems of the invention can be operated to collect information from research center personnel as well as other sources. This is one component of a profile-building tool that allows data to be structured according to questions about general as well as disease-specific capabilities of center. In another dimension, questions can be about extrinsic and intrinsic aspects of a center. In another dimension, data can be factual historical data about clinical trials the research center has participated in or prospective information about clinical trials the centers markets itself as available for.

To update general and disease-specific information in a center profile, research center personnel can access the applications of the invention and “claim” the center they represent.

FIG. 2 shows a screen through which a research center representative could browse to the location of their center and see a list allowing them to click on a link to claim their center. Claiming a center to edit the profile can require authenticating yourself to the system. This can involve, for example, creating a login and password, verifying their official affiliation with the center, or responding to an invite to join the system. Upon claiming their center, personnel can be given the opportunity to edit or update the center profile.

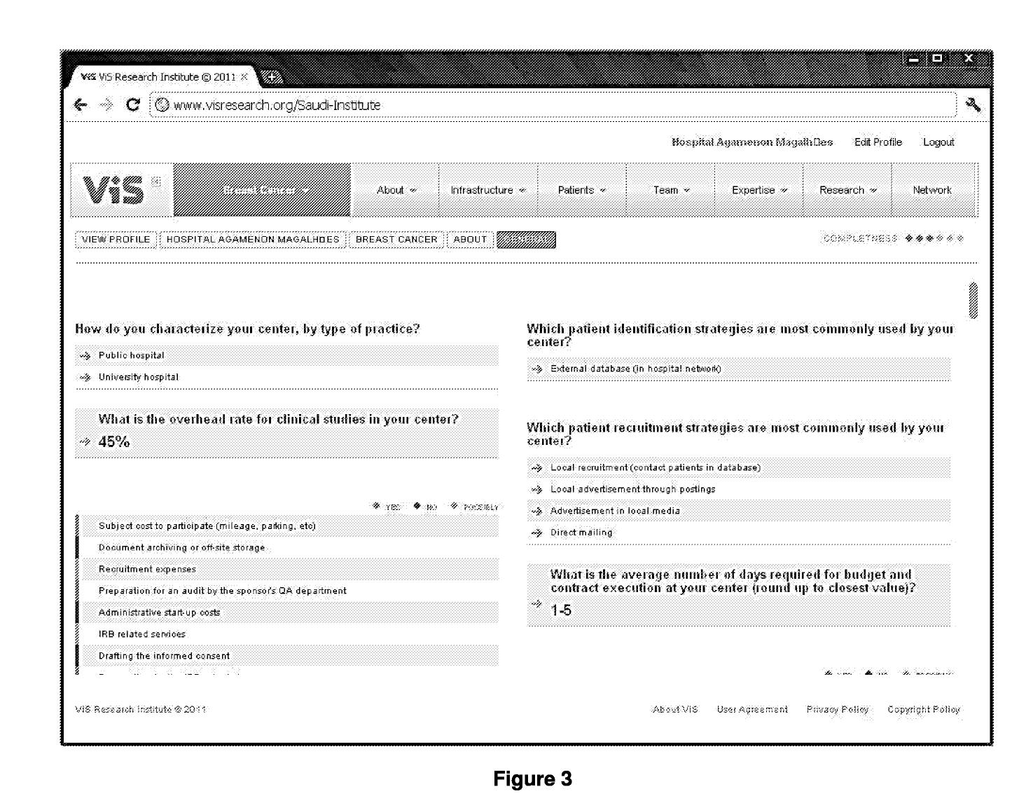

FIG. 3 shows a part of a center profile according to certain embodiments, including the availability of the “Edit Profile” link near the top-right of the screen.

Updating the center profile can involve answering a series of questions, grouped by diseases. For each disease, a list of questions can be presented. In some embodiments, the answers are pre-populated, based on information automatically gathered over the Internet, for example, from publically available databases or inferred from publications. For example, in some embodiments, publication text is retrieved via the PubMed web site of the U.S. National Library of Medicine of the National Institutes of Health (Bethesda, Md.). Articles that are categorized as ‘clinical trials’ are scanned for keywords identifying diseases. Locations are scanned from author credentials, and technology is identified based on keywords associated with materials or methods sections. Program code operates to generate a pre-filled answer indicating that the identified location has the identified technological capacity and that answer is stored in the center profile for that location. This information is then stored in a category defined by the identified disease.

When the center personnel then logs in and proceeds to edit or update their center profile, they can verify that their center has that technological capacity, or update it, if desired. The application can proceed to present any number of questions, with answers either pre-populated or not, to the personnel and collect answers for the center profile.

In certain embodiments, editing the center profile includes providing information about available patient populations, both in general and for specific diseases. In preferred embodiments, patients are anonymous and aggregate, statistical, or demographic data is solicited and received in systems of the invention. Patient data can include, in total or for any disease, a number of patients as well as any other population characteristics such as age structure (e.g., in the sense of an age structure pyramid or actuarial life table) with axes optionally for gender, ethnicity, health or other factors (e.g., education, income, residency, etc.). Patient data can include information about sets of patients that have previously participated in studies, that are presently participating or that are prospectively able to participate. Patient data can include historical recruitment returns as well as any other data relevant to recruiting patients into clinical trials. In all cases, patient data is preferably accessible in total and per disease. Accordingly, the invention provides a tool for the marketing of a center's prospective ability to recruit patients into a clinical trial in a disease-specific manner.

One marketing tool valuable for clinical research centers is the competencies of center personnel and investigators. Editing a center profile can include providing information about those personnel or editing or updating such information. In some embodiments, a center profile includes data sets capable of being displayed on web pages to show personnel or investigators associated with a center. Those personnel affiliations can be shown in total or in a disease-specific fashion. For example, Dr. Jo may work at Alpha Center and be a specialist in hepatitis. Dr. Terry may work at Alpha Center, specializing in CNS diseases. A center can market itself using systems of the invention by editing its center profile to include Drs. Jo and Terry in a list of the total center's personnel affiliations. However, the center can further edit its profile so that when a trial planner sorts by disease, the profile will list only Dr. Jo under hepatitis and only Dr. Terry under CNS disease.

In certain embodiments, the invention includes tools to pre-identify center personnel and pre-populate the relevant parts of a center profile, so that representative of the center need not fill out that part of the profile, or so that a representative of the center can log in and confirm that the pre-populated center personnel affiliations are correct. In fact, in some embodiments, pre-population of center personal plays an operative role in driving the successful promotion of the trial planning tools disclosed herein. It is contemplated that clinical trial investigators and other medical professionals may be attracted to scrutinize a profile upon discovery of the fact that they are themselves already listed as affiliated with an organization. This information can be automatically pre-populated and displayed publically, or pre-populated and kept private, pending verification by the appropriate individual (to whom an email can be transmitted upon the automatic pre-population step using, for instance, an email address as scanned from the text of a publication from which the personnel's affiliation with the institution is also scanned). A medical professional may be interested to see that they have been listed as affiliated with a clinical research center that is being promoted as prospectively available to conduct clinical trials. That professional may review the listing and create a log in to confirm or edit their listed affiliation with the center. At this stage, a pre-populated list of historical collaborations can be presented to the professional, who can be prompted to verify or edit the listing of historical collaborations.

To pre-populate the publication portions of a profile, a history of clinical collaborations can be retrieved from publically accessible databases of clinical trials (see discussion above) for from scanning appropriate document listings in online libraries (see discussion of PubMed above). Publication references can be retrieved and listed as found, or regular expression can be used to extract author names, article titles, journal names, vol: first page-last page, and year. From this data, presumptive collaborations among joint authors can be identified (i.e., jointly listed authors on a clinical trial publication can be presumed to have co-collaborated on the study), and those professionals can be listed in their respective profiles as having collaborated with one another, in total or in a disease specific matter. That is, if a publication relates to a disease (e.g., cerebrovascular disorder), in some embodiments, where a person browses to a center profile in general and without having specified a disease, under the personnel page, they will see the affiliated co-author of that paper and further see a link or text indicated that the one affiliated author has collaborated with the other co-authors of the paper. However, in some embodiments, a person browsing profiles will not see this collaboration information until they have specified cerebrovascular disorder.

Using tools such as those described above, systems of the invention can present an interface allowing a center representative to edit the profile of the center. In certain embodiments, a center representative can get to this interface first by browsing a display of the invention as any other trial planner would. For example, a person can view a web site generated by systems of the invention (e.g., in HTML5, based on geo-referenced data about a plurality of different clinical research centers distributed about the globe). The person can use a computer mouse, touchscreen, or other means, and browse and zoom until a link to their center is shown on the screen. The person can operate that link (or an affiliated link that reads “edit profile” or similar) and be taken to a screen to edit the profile. Of course, in other related embodiments, a person can be taken to a profile home screen simply by logging in (e.g., with a personal or institutional login) or can retrieve the edit profile screen by using a text search box or drop-down menu.

In some embodiments, the ‘default’, or first-displayed edit profile screen contains a series of questions about a center in which this set of questions is not disease-specific. Questions may relate to location, contact information, regulatory environment, or any other information. Questions about a center in general may relate specifically to any of: type of practice; patient identification strategies (internal database, external database); patient recruitment strategies (database, advertisements, referrals); overhead rate; sponsor expenses (subject participation cost, document archiving, recruitment, Internal Review Board/Internal Ethics Committees (IRB/IEC), overhead); IRB/IEC procedures; local health authorities practices; costs for any step (e.g., IRB/IEC protocol review); or any other aspect of operating a clinical trial.

It will be appreciated that the content of the profiles, such as the questions that are written, how the answers are worded or displayed, or what information is featured most prominently, may evolve as industry best practices develop. For criteria that may be important to trial planners generally, and thus that may be included in profile-building questions of the invention, see Warden, et al., Rationale and methods for site selection for a trial using a novel intervention to treat stimulant abuse, Contemp Clin Trials 33(1):29-37 (2012); Potter, et al., Site selection in community-based clinical trials for substance use disorders: strategies for effective site selection, Am J Drug Alcohol Abuse 37(5):400-7 (2011); Taylor, et al., Optimizing stroke clinical trial design: estimating the proportion of eligible patients, Stroke 41(10)2236-8 (2010); and Maggon, Investigator and site selection and performing GCP clinical studies in India, Control Clin Trials 25(4):366-77 (2004), the contents of which are incorporated by reference herein in their entirety for all purposes. Further discussion may be found in Demeter J. Selecting sites and investigators. An approach for Central and Eastern Europe. Appl Clin Trials 11(3):56-66 (2002); Bleyer W A. The U.S. pediatric cancer clinical trials programmes: international implications and the way forward. Eur J Cancer 33(9):1439-47 (1997); Topol E. J., et al., For the Virtual Coordinating Center for Global Collaborative Cardiovascular Research (VIGOUR) Group. Perspectives on large-scale cardiovascular clinical trials for the new millennium, Circulation 95(4):1072-82 (1997); Mahony L, et al., Pediatric Heart Network Investigators. The pediatric heart network: a primer for the conduct of multicenter studies in children with congenital and acquired heart disease. Pediatr Cardiol 27(2):191-8 (2006); Atkinson, Using the Internet to search for cancer clinical trials: a comparative audit of clinical trial search tools, Contemp Clin Trials 29(4):555-564 (2008), the contents of which are incorporated by reference herein in their entirety for all purposes.

Using systems of the invention, center personnel can provide general information about their center. General information about a center may include type of practice, patient identification strategies, patient recruitment strategies, overhead rate, sponsor expenses, IRB/IEC procedures, and local health authorities practices. Center personnel can provide general information relating to the location of the center. Information relating to the location may include facts about national regulatory approvals; languages that need to be used; and time for import or import license for study drug. Center personnel can further update the profile to include information about the infrastructure for the center. Information about the infrastructure may include information about the availability of office space, an operating room, visit space, security, internet, document storage, overnight facility, space for blood draws, dry ice, centrifuge, −70 degree freezer, ultrasound, radiology lab, MRI scan (for example, by type: diffusion MRI, fluid attenuated inversion recovery (FLAIR), magnetic resonance gated intracranial CSF dynamics (MRI-GILD), functional, T1-weighted), CT scan, medical labs (e.g., clinical pathology, biochemistry, hematology, microbiology), and lab methods (e.g., counter-immunoelectrophoresis, ligase chain reaction, ELISA, FISH, Western blot, immunofluorescence assay, KRYPTOR assay, RT-PCR, HPLC).

After answering general questions about a center, a person editing a center profile may answer sets of disease-specific questions.

In some embodiments, the questions are presented in the format of, under the heading of a specific disease, “Does your center have the capacity for the following?” Beneath the heading may be a list of questions, and each can have an answer field. In some embodiments, the answer field is a set of a radio buttons (e.g., multiple choice) and the values can be, for example, “yes,” “no,” and, “can be arranged.” Additionally or alternatively, the answer fields can include a text entry field, a pull-down menu, or any other such element known in the art.

As is discussed elsewhere herein, the questions may be pre-answered by automatic processes performed by computer systems of the invention (e.g., searching databases of clinical trials for reports of having used certain technologies in the investigations of certain diseases, which can result in pre-populating an answer “yes” to the question pertaining to that technology under that disease).

Whether answers are pre-populated or not, systems of the invention operate to present lists of questions or information-gathering fields during the profile edit process. A list of exemplary subject matter for a variety of questions, presented in sets organized under specific diseases, is presented in the following paragraphs.

Where the disease is identified as “adult cognitive disorder (and/or Alzheimer's)” (or similar), questions may relate to any of the following, without limit-B12 Deficiency; Thyroid profile; apolipoprotein E (APOE) Test; Amyloid Precursor Protein (APP) mutation; presenilin 1 (PSEN1) mutation; Presenilin 2 (PSEN2) mutation; Computer-Administered Neuropsychological Screen for Mild Cognitive Impairment (CANS-MCI); Tau Proteins; Levels of beta-secretase (BACE1); Levels of amyloid beta 42 (Aβ42) peptide; plasma transthyretin; functional brain imaging with (18F) fluorodeoxyglucose positron emission tomography (FDG-PET); and Magnetic Resonance Spectroscopy (MRS).

Where the disease is identified as “Arrhythmia” (or similar), questions may relate to any of the following, without limit: Electrophysiology Study; In Hospital Telemetry; Holter Monitoring; external loop recorders; post-event recorders; auto-detect recorders; Implantable loop recorders; and Real Time Continuous Cardiac Monitoring System.

Where the disease is identified as “Breast cancer” (or similar), questions may relate to any of the following, without limit: PARP expression; Human leukocyte antigen (HLA) Typing Test; Film Screen Mammography; Full Field Digital Mammography (FFDM); scintimammography; Thermography; Breast cancer susceptibility (BRCA) genes; Tumor M2-PK EDTA Plasma Test; Serum Carcinoembryonic Antigen (CEA); Tissue inhibitor of metalloproteinases-1 (TIMP-1) Test; CA 15-3 assay; gross cystic disease fluid protein-15 (GCDFP-15); cytokeratins 7 and 20 (CK7 and CK20); mammaglobin expression; and uPA and PAI-1 status.

Where the disease is identified as “cerebrovascular disorder” (or similar), questions may relate to any of the following, without limit: D-dimer level; protein C and protein S; prothrombin (F2) G20210A mutation; factor V Leiden mutation; and plasma miR-124.

Where the disease is identified as “CNS infection” (or similar), questions may relate to any of the following, without limit: Blood culture; CSF culture; Latex agglutination Test; Kovac's Oxidase Test; Quellung Reaction; Optochin Sensitivity Test; Bile Solubility Test; spot indole test; ornithine decarboxylase test; urease test colorectal cancer” (or similar), questions may relate to any of the following, without limit: K-ras gene analysis; Tissue inhibitors of matrix metalloproteinases-1 (TIMP-1) Test; Serum Carcinoembryonic antigen (CEA); microRNA (miRNA) screening assay; Double contrast barium enema (DCBE); Guaiac-based Fecal Occult Blood Test (gFOBT); Fecal Immunochemical Test; Fecal DNA Test; tumor M2-PK stool test; rectal mucus-galactose oxidase Schiff test; tumor M2-PK EDTA plasma Test; cytokeratins 7 and 20 (CK7 and CK20); and CA19-9.

Where the disease is identified as “diabetes” (or similar), questions may relate to any of the following, without limit: impaired glucose tolerance (IGT); hemoglobin A1C (HbA1c) levels; plasma C peptide levels; plasma beta-hydroxybutyrate (BHOB); intra-arterial Calcium Stimulation; Capillary blood glucose testing; Asymmetric dimethyl-arginine (ADMA); Autoantibodies Markers in Type 1 Diabetic patients; and ZnT8 in Type 1 Diabetic patients.

Where the disease is identified as “dyslipidemia” (or similar), questions may relate to any of the following, without limit: lipid profile; serum Lp (a) levels; Apo E genotype DNA test; malondialdehyde (MDA) and protein carbonyl (PCO) levels; serum advanced glycation endproducts (AGEs); and Adipocyte fatty acid binding protein 4 (FABP4)/adiponectin ratio.

Where the disease is identified as “hematalogic cancer” (or similar), questions may relate to any of the following, without limit Human leukocyte antigen (HLA) Typing Test; Philadelphia chromosome status; Serum protein electrophoresis (SPEP); Urine protein electrophoresis (UPEP); immunofixation; tissue inhibitors of matrix metalloproteinases-1 (TIMP-1) test; gallium scan; multi-parameter flow cytometry; BCR-ABL1 fusion protein; and Beta-2-microglobulin (B2M) blood levels.

Where the disease is identified as “HIV infection” (or similar), questions may relate to any of the following, without limit: HIV-1 Antibody Test; HIV-2 Antibody Test; Viral Load; CD4 T-Cell Count; p24 Antigen Test; Genotypic Resistance assay; Phenotypic Resistance assay; and HLA-B* 5701 Screening.

Where the disease is identified as “hypertension” (or similar), questions may relate to any of the following, without limit: sphygmomanometry; plasma aldosterone to renin ratio; plasma renin activity; oscillometric devices; and Holter Monitor.

Where the disease is identified as “influenza” (or similar), questions may relate to any of the following, without limit: Shell viral culture; isolation in cell culture; rapid antigen detection test; neuraminidase detection assay; haemagglutination inhibition (HAI) test; and micro-neutralization assay.

Where the disease is identified as “ischemic heart disease” (or similar), questions may relate to any of the following, without limit: troponin test; creatine kinase (CK-MB) test; glycogen phosphorylase isoenzyme BB (GPBB); myeloperoxidase (MPO); C-reactive protein (CRP); plasma atrial natriuretic peptide (ANP) and brain natriuretic peptide (BNP); asymmetric dimethyl-arginine (ADMA); homocysteine levels; and ischemia-modified albumin (IMA).

Where the disease is identified as “lung cancer” (or similar), questions may relate to any of the following, without limit: MAGE-A3 gene expression; EML4-ALK fusion gene expression; tumor M2-PK EDTA plasma test; serum carcinoembryonic antigen (CEA); tissue inhibitors of matrix metalloproteinases-1 (TIMP-1) test; color sensor breath test; Sputum Analysis; Cytokeratins 7 and 20 (CK7 and CK20); thyroid transcription factor-1 (TTF-1) expression; 3p chromosomal deletions; K-ras oncogene and p21ras expression; and neuron specific enolase (NSE).

Where the disease is identified as “mood disorder” (or similar), questions may relate to any of the following, without limit: thyroid profile; lumbar puncture; electroencephalogram (EEG). In the case of movement disorder” (or similar), questions may relate to any of the following, without limit: olfactory testing; quantitative sudomotor axon reflex test (QSART); alpha-synuclein levels; ubiquitin specific proteases 24 (USP24); Parkinson protein 7 gene (PARK7); Leucine-rich repeat kinase 2 gene (LRRK2); PTEN-induced putative kinase 1 gene (PINK1); and Parkinson protein 2 gene (PARK2).

Where the disease is identified as “pneumonia” (or similar), questions may relate to any of the following, without limit: blood culture; sputum culture; pleural fluid culture; endotracheal fluid culture; urinary pneumococcal antigen test; urinary Legionella antigen test; procalcitonin (PCT) test; C-reactive protein (CRP) test; soluble triggering receptor expressed on myeloid cell-1 (sTREM-1) levels; and pulse oximetry (SpO2).

Where the disease is identified as “prostate cancer” (or similar), questions may relate to any of the following, without limit: serum testosterone; serum PSA levels; prostate cancer antigen 3 (PCA3) urine test; tumor M2-PK EDTA plasma test; tissue inhibitor of metalloproteinases-1 (TIMP-1) Test; and Cytokeratins 7 and 20 (CK7 and CK20).

Where the disease is identified as “schizophrenia” (or similar), questions may relate to any of the following, without limit: Scratch-and-sniff smell Test; Disrupted-in-schizophrenia-1 (DISC-1) mutation; neuregulin 1 (NRG1) gene; brain-derived neurotrophic Factor (BDNF) gene; and N-methyl-D-aspartate (NMDA) receptor.

Where the disease is identified as “seizure disorder” (or similar), questions may relate to any of the following, without limit: Electroencephalogram (EEG); Gamma-aminobutyric acid (GABA) A receptor, gamma 2 (GABRG2) mutation; and Ion Channel mutations.

Where the disease is identified as “viral hepatitis” (or similar), questions may relate to any of the following, without limit: Anti-HAV IgM; Anti-HAV Total; HAV RNA assay; HBV DNA assay; HBsAg; Anti-HBs; Anti-HBc Total; Anti-HBc IgM; HBeAg; Anti-HBe; HCV Genotype Test; HCV RNA Test; Anti-HCV; HDAg; HDV RNA assay; Anti-HDV Total; Anti-HDV IgM; HEV RNA assay; Anti-HEV IgG; and Anti-HEV IgM.

Further, additionally and alternatively, systems of the invention can automatically retrieve answers for these questions using database search and query functions as programmed according to programming methodologies known in the art in languages or development environments discussed in greater detail below.

By using the automated tools to pre-load information retrieved from databases of clinical trials, databases of publications, from the input of other persons whom have collaborated with more than one center, the profiles of centers can have investigators and other personnel pre-identified. Accordingly, the invention provides tools that make the upload of technical information quick and efficient, by preloading information identified to be pertinent to the center.

Further, while information is organized into sets by disease, information can be automatically populated across sets where applicable. For example, where a person edits a profile under the heading of “osteoporosis” to indicate that they have an x-ray machine, under the heading of “trauma treatment”, the availability of an x-ray machine can be affirmatively listed. In some embodiments, where an investigator in one center indicates that that center has certain equipment and that that center often collaborates with a second center, the availability of that piece of equipment under the second center can be automatically pre-populated as “can be arranged”. Further, general questions can be scripted and presented by a computer program before the disease-specific questions are asked and where certain categories of information are of general as well as disease-specific importance (e.g., helipad may appear under general information as well as under trauma treatment; x-ray may appear under general information as well as osteoporosis), those questions can be asked once as general questions and used to populate the disease-specific profiles. Thus the invention provides integration of general questions with disease-specific questions so that the center representatives do not have to repeat the general information for each disease-specific profile.

It will appreciate that systems and methods of the invention allow for quick updating of infrastructure information, allowing centers to share them with interested trial planners in a time-efficient manner. For example, if certain jurisdiction certify medical sites contingent on certain inspection outcomes, each annual inspection can promptly be recorded in the center profile. In fact, in some embodiments, future prospective events (such as governmental inspections) are indicated in a profile so that trial planners can be aware of upcoming significant events.

Using systems and methods of the invention to market their clinical trial capacity, as well as to promote the competencies and qualifications of their personnel and their history and activity in clinical trials, centers can establish and control relationships with other stakeholders such as other centers, trial planners, investigators, sponsors, and government personnel, for example.

Networking Tool

In certain aspects, the invention provides tools by which professionals can build networks, or digital representations of their global connectivity as relates to capacity to participate in clinical trial. Entities, or nodes, in networks can be individual investigators, research centers, other entities (e.g., academic institutions), or a combination thereof.

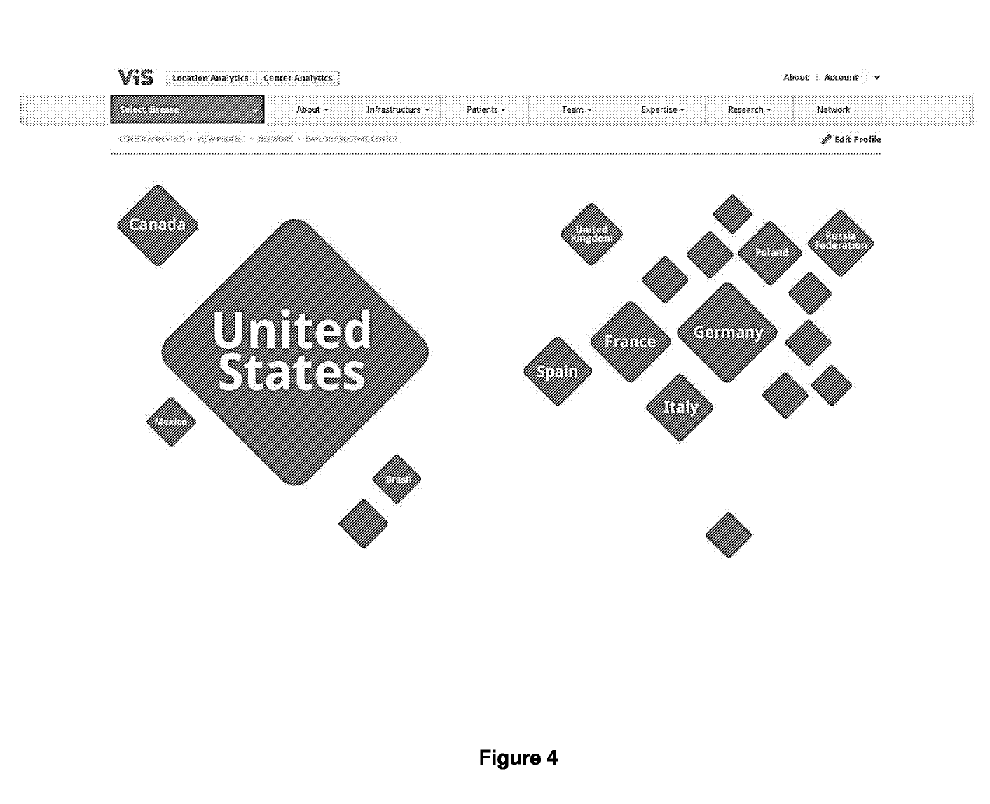

FIG. 4 shows a home screen for viewing a network. Here, the network of the Baylor Prostate Center is illustrated. From this display, one may see that Baylor Prostate Center has, in its network, entities in Canada, United States, Mexico, Brazil, United Kingdom, Spain, France, etc. Those entities may include other research centers or personnel. In general, a network may refer to connections defined by past collaborations, institutional affiliations, potential or intended collaborations, or collegial affiliations. In certain embodiments, the invention provides systems and methods for building and populating networks. Tools for network building include automatic, internet-searched based tools as described elsewhere herein, as well as user-interface tools by which personnel can update and edit their network connections.

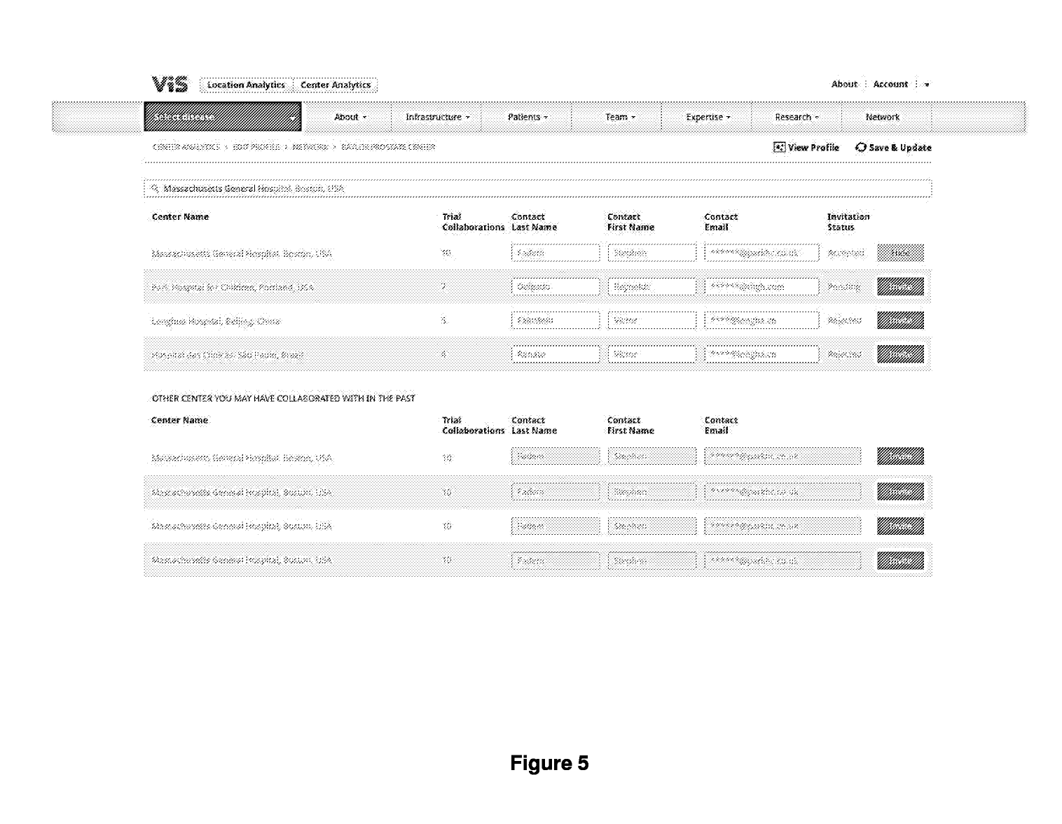

FIG. 5 shows an exemplary screen by which a representative of Baylor Prostate Center may edit their network. As shown in FIG. 5, the system is displaying four institutions with which the entity has established network connections (e.g., Massachusetts General Hospital, Park Hospital, Longhua Hospital, and Hospital das Clinicas). Furthermore, the system is displaying institutions and individuals that have been discovered and pre-populated as candidates or further inclusion in the network. Here, for example, the system has suggested that a Dr. Fadem may have a history of 10 collaborations with personnel from the Baylor Prostate Center. To further develop the network personnel from the Baylor Prostate Center may wish to invite Dr. Fadem to join the network.

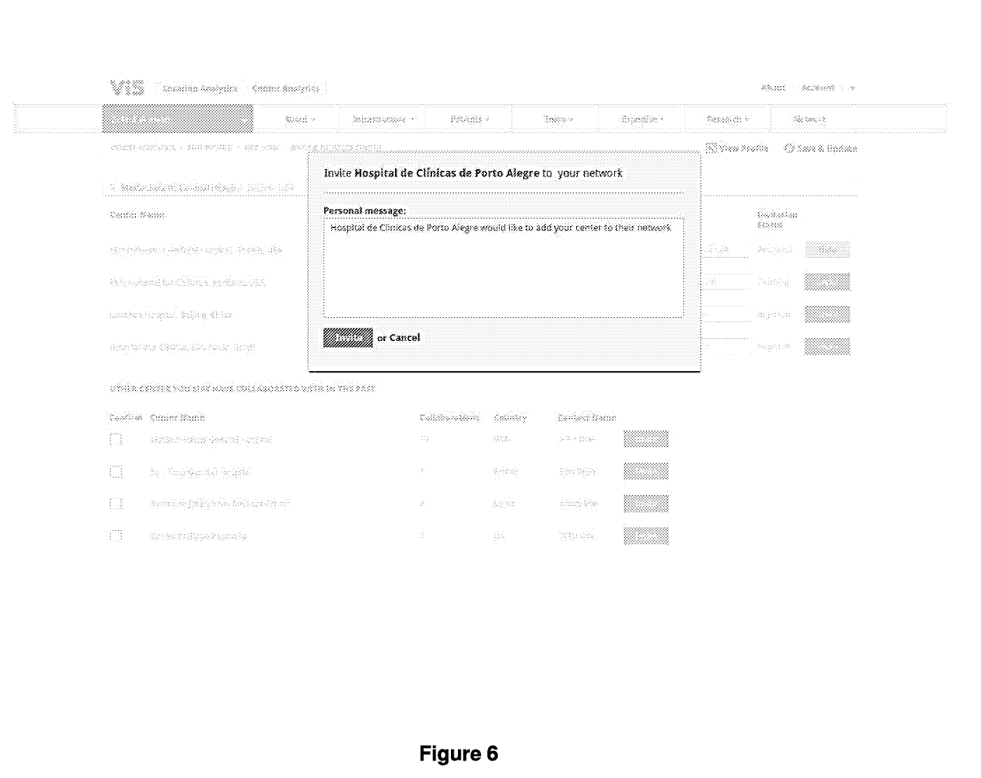

FIG. 6 shows a screen for inviting an entity to join a network. Networks can include nodes and connections. A node is generally a representation of an entity, and may include affiliated entities (although an affiliation with an entity can be a connection). Entities can be any entity, such as centers, investigators, sponsors, etc. Connections can be historical collaborations, other collaborations, institutional affiliations, co-authorship, etc. Use of networks provides a tool for centers to market themselves by demonstrating to trial planners the inherent capacity to participate in multi-site clinical trials. Use of network further provides a mechanism to drive participation in systems of the invention. It is contemplated that upon receipt of a network invitation, individuals will be motivated to accept and join the network, for example, to promote their own institutional and professional accomplishments and capacity.

Profile Rendering

In some aspects, the invention provides a system for rendering a research entity profile.

A research entity, in general, can refer to an organization that conducts research. In general, research entity is used to refer to an incorporated entity, the leadership of an organization or institution in whatever form it embodies itself (e.g., the partners of a partnership, a person in charge of a lab, an institution as a whole), or a school, non-profit, NGO, government, or company. In general, research center refers to a place, such as the location of a research entity, or a campus or headquarters or lab building or cluster of buildings, or an address of a research entity or research facility, or a component or part of a larger institution or organization. Generally, a research facility is a lab or a location where an experiment is conducted, or a place where a step of an experiment is conducted, such as a hospital ward, or a dorm where patients are housed, or a patient's house or a mobile medical unit. In generally, a research entity (e.g., Regents of the University of California, U.C.S.D., Pfizer, NIH, NASA, Cold Spring Harbor) will include at least one research center (e.g., U.C.S.D., corporate headquarters, Ames Research Center, OHSU primate research center, Woods Hole, Cold Spring Harbor). In general, a research center will include at least one research facility (e.g., Dr. Smith's lab, Division of Surgical Research, Oak Ridge National laboratory, Beckman Center for Molecular and Genetic Medicine, Border Clinical Research Center, SC Clinical Research Center, county health department HIV test site, mobile blood collection van). Typically, an entity will be one, two, or all three of these categories at the same time. In general, research entity, research center, research site, and research facility are used interchangeably, except where an aspect of an entity is to be indicated. Some research entities include more than one center and more than one facility. Some research facilities are accessed by, or included within, more than one research center or research entity. Generally, a facility will have at least one specific location such as a building, area, or campus, and typically a center may have at least one main location. In some cases, an entity has a main location or a single location. In general, research is conducted, at least in part, at a research facility. A research center generally is the campus, building, or division housing the facility. And generally, the entity is the company, school, or governmental agency under which the center exists.

Systems and methods of the invention obtain information about a research entity and store it in a database. For example, a database can include a file on a computer into which information is input. Information about a research entity can include the identity of the entity. Generally, at least one other fact about the entity will be obtained, such as an address (e.g., postal address or physical address). Information that can be obtained includes details about clinical trials that have been conducted at a facility, names or CVs of personnel, location, climate, a picture, costs of studies, identities of co-collaborators, lists of publications, or anything else concerning the entity. Information can be obtained by searching the web, or retrieved in bulk from a database or commercial provider (i.e., Frost & Sullivan, a phone book, Google search). Information can be put into the system, for example, by a system administrator. In some embodiments, representatives of the research entities enter information into the system, for instance, because they want to use the system as a marketing tool, or because they want to see certain information made available.

Storing information in a database generally includes writing to a file. Writing to a file typically includes transforming a tangible, non-transitory computer-readable medium, as discussed elsewhere herein.

In some embodiments, a database is provided by an outside vendor. Information can be stored by delivery to an outside database or storage within a local database. A database—local, outside, or hybrid—can be created in Structured Query Language (SQL) Database, MySQL, or Microsoft Access. A database according to the invention can also include a data file of information, without reference to any particular format or language. A database according to the invention can also include an information or research service. Databases and profiles are described in U.S. Publ. 2003/0191664, U.S. Pat. No. 7,054,823, U.S. Pub. 2002/0023083, U.S. Pub. 2009/0089392, U.S. Pat. No. 7,647,240, U.S. Pub. 2010/0211411, U.S. Pub. 2003/0108938, U.S. Pub. 2006/0287997, and U.S. Pub. 2004/0078216, each of which is herein incorporated by reference in its entirety.

Information stored in a database can be prepared for access by rendering a profile. The invention provides methods for rendering a profile for a research entity. In certain embodiments, the invention provides a disease-specific profile for a research entity. Thus, a lab can have, for example, an impetigo profile and a breast cancer profile. In some embodiments, a lab or center will have profiles that are very specific for categories of disease or more general. Thus, there could be a profile for Johns Hopkins Cancer and Johns Hopkins Allergies, or there could be profiles for Sidney Kimmel Teratoid/Rhabdoid Tumor and Sidney Kimmel Merkel Cell Carcinoma. A profile generally includes a collection of information related to a clinical research facility and optionally its activity relating to a disease.

Systems and methods of the invention compose or render profiles, which can include information from a database. Compose, generally, includes determining elements to make up a profile, or to prepare such elements for display. Composition in some embodiments is performed by a processor. Composing, in some embodiments, includes writing information to a file (writing to a file is discussed elsewhere). For instance, composing can include the steps of reading (e.g., by a processor) information from a database, processing the information according to instructions, and creating output (e.g., XML, HTML5, HTML, text, an image such as a jpeg, ping, or tiff, or any other output) capable of being displayed or rendered. This output can be written to a file. In certain embodiments, composition includes choosing, e.g., based on criteria (i.e., user-supplied criteria, criteria that result from a calculation or logical operation, externally obtained), information to occupy or define fields of a profile. Such fields could be fields for title, name of entity, disease, location, facility size, number of previous studies, availability, availability of patients for particular study type, peer-review setting, notes, or any other information item. Composing a field can include concatenating two or more information items (i.e., “Johns Hopkins” plus “diabetes” to yield a profile title “Johns Hopkins diabetes center profile”). Composing can also include parsing information. In general, composing a profile will produce a data file—stored in memory or delivered to a display device—containing information pertinent to a profile and capable of being displayed. For example, composition can produce an XML file, which when rendered by a browser, produces a display of a profile. Composition can include a step of causing a display, or can include steps preparatory to such a step.

Rendering generally refers to the process of showing a composition so that a human could perceive it. For example, a web browser's (i.e., Internet Explorer, Dolphin Browser HD v. 7.2.0, Google Chrome, etc.) display of HTML, HTML5, XML according to a cascading style sheet (CSS), Flash animation, Java animation or display, or other file (e.g., text file) generally is a rendering. Rendering also includes sending data to a printer or other processing unit (i.e., a postscript file writer, Adobe distiller, or similar), for example, to print a composition on paper or other material.

A composition generally includes one or more information items, as retrieved from a database or the internet, or as calculated or processed by a processor based on inputs from a database or the internet. Information for a composition is generally obtained by using one or more criteria and identifying suitable information. Profiles are composed based on one or more criteria, which can be chosen through the use of various input means. For instance, the invention can supply to a user a location field, in which user can key in the name of any country, state, city and postal code in the world. Other input means include a field for choice of disease of interest, fields for extrinsic or intrinsic center characteristics, as well as visual displays that a user can interact with (i.e., select a geographical criterion by drawing a box around it).

A user may use a computer terminal to put in the identity of a disease. A user may interact with a computing device to indicate that they are interested in clinical trials, hypertension, and Singapore. To obtain input, according to certain embodiments, system of the invention can create output capable of being displayed to collect more specific information. For example, based on the user's criteria, the invention can cause the display of hypertension research locations. Systems and methods of the invention can further show more narrow results, for example, showing a display of a list of four hypertension research facilities in Singapore according to the invention.

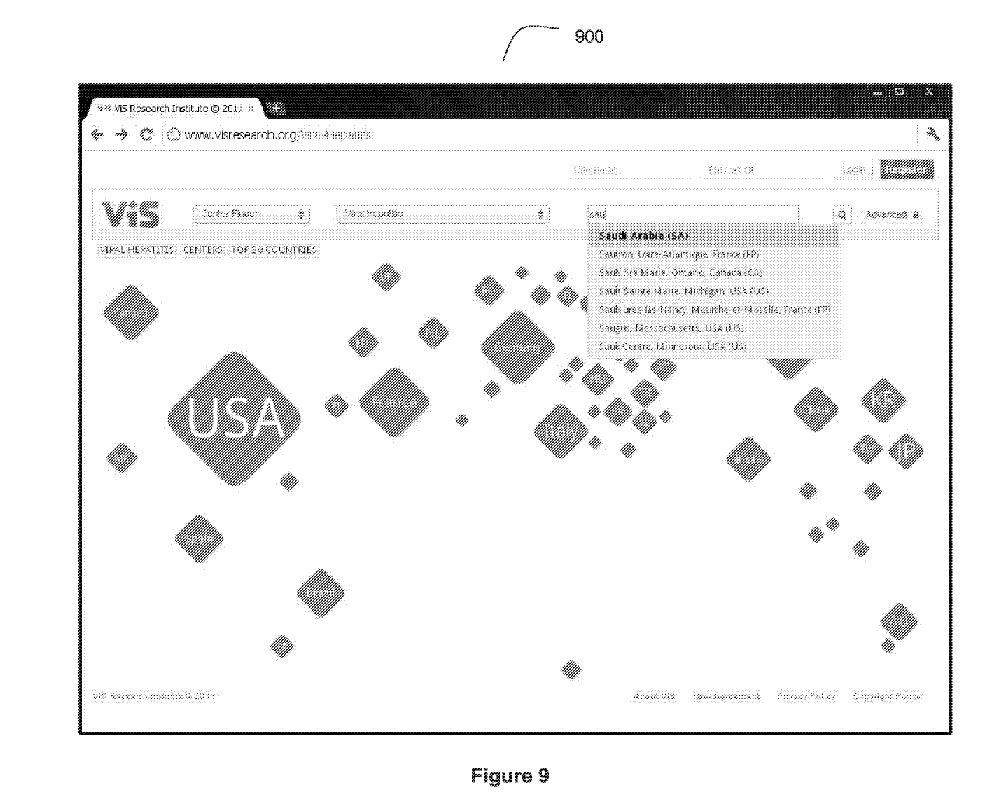

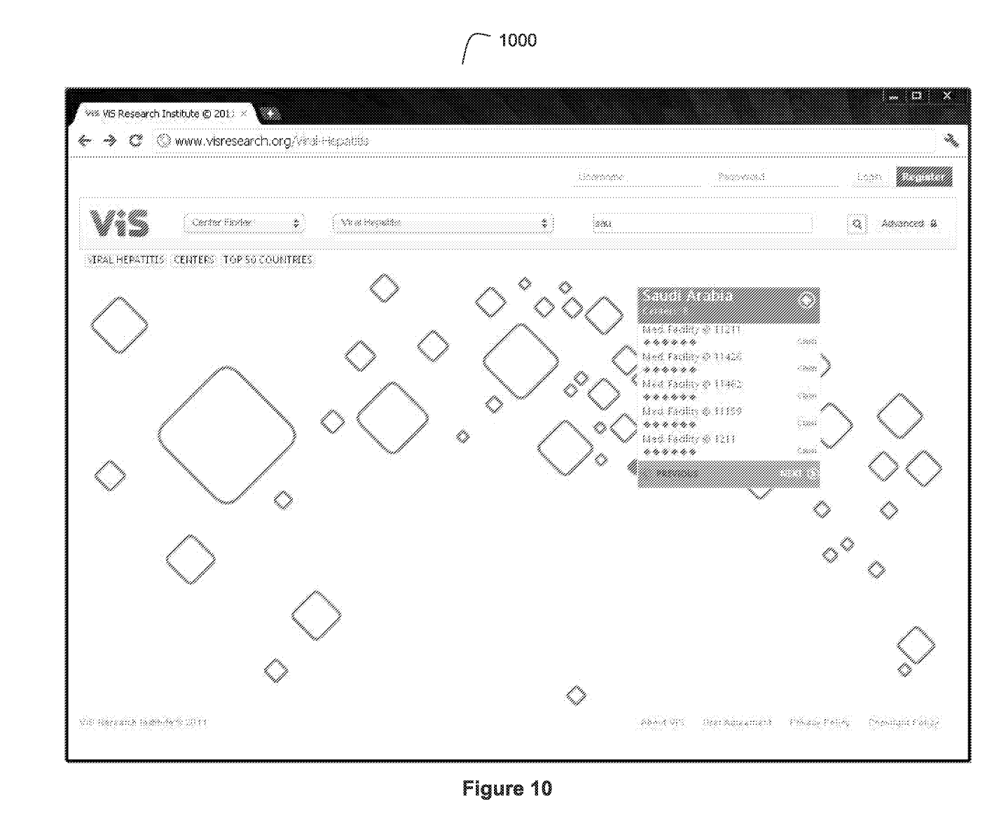

Using systems and methods of the invention, a user could find research centers, for example, suited to doing research on a particular condition or disease. For example, FIG. 9 illustrates a search for viral hepatitis research facilities in Saudi Arabia, which a user instigates by putting the country name into the location field. Similarly or in the alternative a user could search for viral hepatitis and click on a displayed element corresponding to Saudi Arabia, to show a list of 8 viral hepatitis research facilities in Saudi Arabia as shown in FIG. 10.

Systems of the invention can then determine if an information item (e.g., a name of a research center or a location of an airport) in the database corresponds to a research entity that conducts clinical trials on diabetes in Asia. Based on the determination that the information item satisfies the criteria, the information item is noted for inclusion in a profile. Generally, a profile as composed or rendered by the invention will include at least an identity of a research entity, research center, or research facility.

After processing two or more information items in this fashion, a composition is produced including information items for a profile. For instance, the composition could include the information: International Medical Center; 1 Hongqiao Rd; Shanghai; 5 diabetes clinical trials in 2010; 650 patients available; 300 beds; 4.5 star average peer review; 55% overhead rate; identifies patients through advertising; requires 3 days for contract execution; recently audited by PTD firm; commercial parking garage across street; nearest airport 1.2 km. A composition could include a name of a research facility. For instance, a composition could include only piece of information, indicating a placeholder status in the database for a database item needing more information.

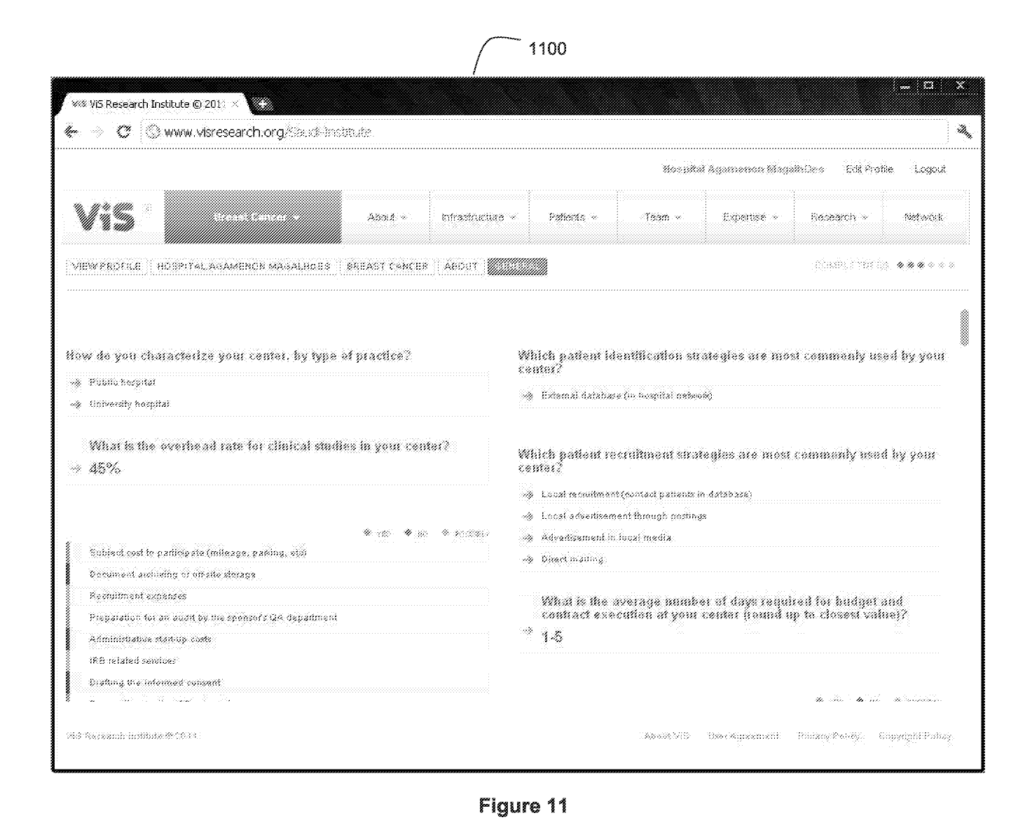

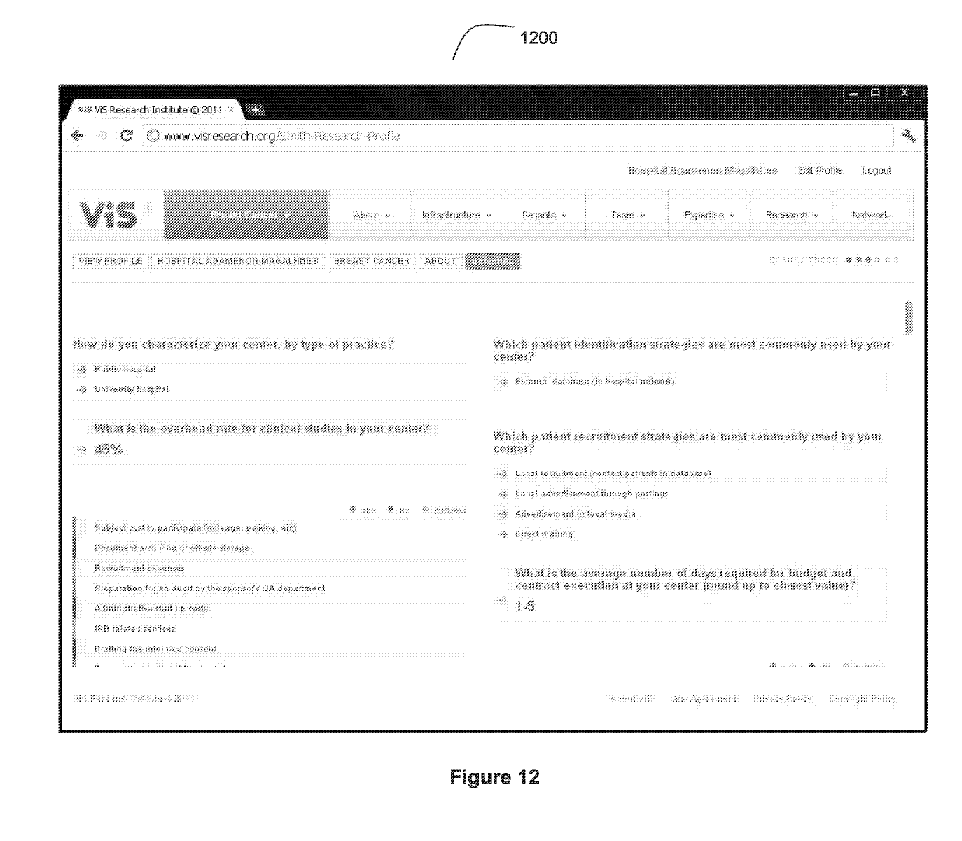

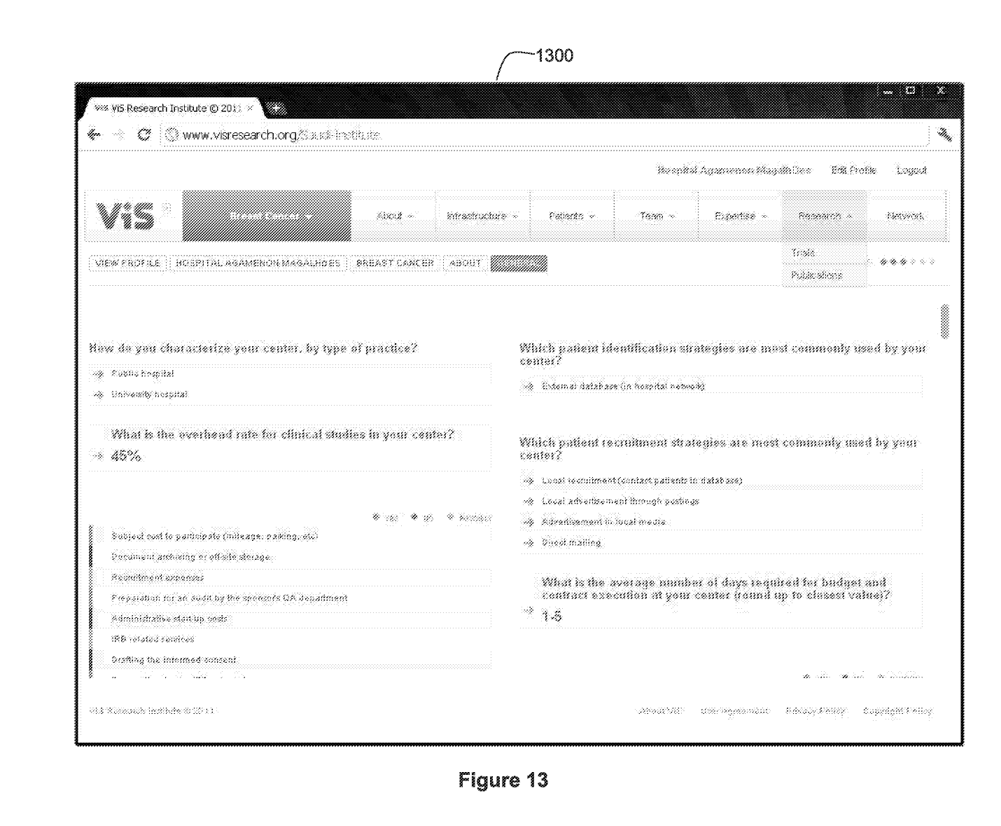

In certain embodiments, systems and methods of the invention compose disease-specific profiles of research entities. For example, a name of a research entity and a name of a disease will correspond to one unique profile. Thus, a research entity can have multiple profiles, each representing a set of facts related to a disease. Some information may be in common between two different profiles for one entity. For example, a profile for breast cancer at Kelsey-Seybold Clinic and a profile for diabetes at Kelsey-Seybold may contain the same contact information, for example, or the same entity name. But those two profiles may also contain different information. One may contain information about clinical trials associated with breast cancer, and the other may contain information about clinical trials associated with diabetes. FIG. 11 shows a breast cancer profile of The Saudi Institute according to the invention. FIG. 12 shows a breast cancer profile of Smith Research according to the invention. FIG. 13 illustrates browsing the trials and publications related to breast cancer from the Saudi Institute according to the invention.

In some embodiments, the invention provides intrinsic and extrinsic information about a research entity. Generally, extrinsic aspects of a research center or facility are location specific. Extrinsic properties include, for example, research infrastructure, research activity, patient population, research personnel, cost, and regulatory environment. The invention can also include the intrinsic properties of the research centers, including both general and disease-specific information about infrastructure, patients, research support personnel, investigators, publications, recruitment performance in clinical trials, and global collaborators. The database optionally includes metrics on historical cost-per-patient for recruitment at each research center, average time-span to recruit a full patient load, or realization rate of recruitment efforts by research centers. Accordingly, a trial planner can include as a search criterion a desired value for one of these metrics.

The invention provides an interactive online clinical research intelligence platform, which enables clinical trial planners to interactively find research centers and evaluate their intrinsic and extrinsic disease-specific characteristics. Systems and methods of the invention enable the trial planner to select a disease or location of interest through interaction with dynamic geo-referenced convex geometric forms distributed on the screen of a computer, tablet or smartphone.

The trial planner can evaluate extrinsic characteristics of the research centers by evaluation of clinical research-related comparative metrics concerning the locations in which the centers operate (including neighborhood, city, state, country, and region). More specifically, the extrinsic metrics are related to local: research infrastructure; research activity; patient population; research personnel; cost; and regulatory environment.

The user can also evaluate the intrinsic capabilities of the research centers by selecting links to their respective profiles, which can be integrated as labels of the geo-referenced icons. Such profiles can be generated partly from input from center representatives and partly from geo-referenced data from the system.

In some embodiments, the research profiles have access restriction set by their representatives and include both general and disease-specific information about: infrastructure; patients; research support personnel; investigators; publications; recruitment performance in clinical trials; and global collaborators. Setting access levels is described in U.S. Pat. No. 7,949,611, U.S. Pat. No. 7,908,208, U.S. Pat. No. 7,562,226, U.S. Pub. 2010/0088364, U.S. Pub. 2004/0093334, U.S. Pub. 2011/0247051, U.S. Pub. 2010/0306858, U.S. Pub. 2010/0306858, and U.S. Pub. 2010/0223673, each of which is incorporated by reference herein in its entirety.

Systems and methods of the invention can provide questionnaires or pre-populated interfaces to allow a center representative to confirm their participation in specific trials, contribution by particular investigators, and publication of particular articles that were identified by the system as likely associated with that center. These center profiles can offer a commercial research network in which the collaborating centers are mutually listed within the profiles of individual centers. Moreover, the same medical institution can have multiple disease-specific profiles, while using the same general information.

The components of the center profile can show the contextualized information about the location in which the center is location and can contain links to a visualization to show comparative extrinsic information.

Further, systems and methods of the invention can include security, publicity, and privacy controls, for example, in the form of user-controlled groups. For example, center personnel can create lists of “allowed” partners who can view the center's full-profiles. In some embodiments, permissions are associated with proximity in a digital network. For example, other centers and personnel with a direct or first-degree relationship can view a full profile or send private messages, while parties with more distal relationships can view a limited profile, or only send form messages or messages to a general inbox. Accordingly, the invention provides access-control features that allow centers to decide who can view their information, and what they can see. Access control security features can operate in real-time. This can allow a trial planner to preliminarily identify a center for inclusion in a prospective study and send an inquiry. Upon a positive reply by the center, which can be triggered by a representative of the center, or by in-system validation such validating the institutional affiliation of the trial planner, that trial planner can be given access to a more full version of the center's profile. In certain embodiments, the trial planner must request or inquire under the heading of a certain disease, and upon validation, the planner is given access to a full version of the center's profile only under that disease.

In some aspects, the systems and methods of the invention provide a profile export feature that allows centers to quickly generate a profile containing all the pertinent information about their capabilities. The export feature can generate a v-card that can be digitally accepted and integrated into other information systems, such as Microsoft Outlook. In some embodiments, the export feature can be used to prepare a fact-sheet, such as a PDF digital file, that a center representative can then use as a promotional tool. In certain embodiments, exporting tools are used for report generation, for example, at the end of a year to generate statistical reports about clinical trials and patient participation. Such reports may be used, for example, in government reporting or publications. In some embodiments, export tools of the invention allow a medical professional such as an investigator to automatically create and format a text document for inclusion in a resume or cv, for example, as a publication list.

In certain embodiments, systems and methods of the invention integrate with information systems or enterprise resource planning systems or marketing software to feed into those systems aggregate data about patient contacts, potential clinical trial contacts, or other data.

As will be appreciated from the discussion herein, systems and methods of the invention may be implemented through the use of computer hardware and software. Implementations of systems for clinical trials are discussed, for example, in U.S. Pat. No. 7,711,580; U.S. Pub. 2006/0178906; and U.S. Pub. 2009/0292554, the contents of each of which are incorporated by reference herein in their entirety for all purposes.

Systems of the invention can include one or more computer devices.

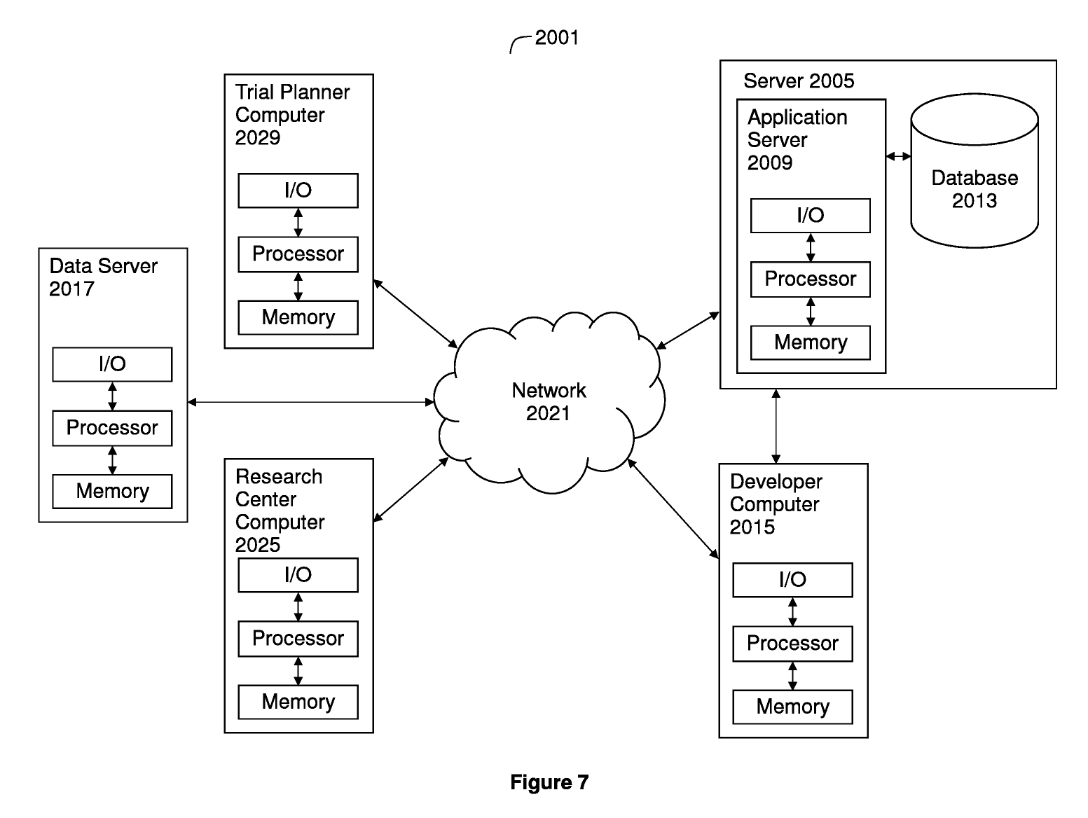

FIG. 7 shows an exemplary computer systems according to certain embodiments. In some embodiments, the invention provides a system 2001 including a server 2005 that can include application server 2009 and database 2013, either as a single computer device or a combination of multiple computer devices. In general, a computer device is an apparatus with an input/output (I/O) mechanism coupled to a processor that is coupled to a tangible, non-transitory memory.

System 2001 generally includes one or more computers including, for example, any of server 2005, developer computer 2015, trial planner computer 2029, research center computer 2025, and a data server 2017, and computer of system 2001 may generally communicate by sharing data with one another over network 2021. In some embodiments, server 2005 includes application server 2009 configured to collect or receive information relevant to one or more of a research center, investigator, publication, clinical trial, disease, medication, medical hardware component, or similar, or combination thereof. In some embodiments, the invention includes database 2013, for example, stored in the memory of server 2005 or as a separate hardware component with its own computer hardware, for example, accessible by application server 2009.

Server 2005 can be configured to receive, through its input I/O device, input over network 2021. As discussed above, client input can include a criterion for a search or an interaction with a display. Client input can also include a login (i.e., username) or password.

Any or all of the depicted computers may include, stored in memory, instructions for causing the machine to perform any one or more of the methodologies discussed herein. In some embodiments, systems of the invention are deployed in a networked deployment and network 2021 represents the Internet, a LAN, a Wi-Fi network or a combination thereof. For example, server 2005 may be operable via a LAN while trial planners and research center personnel access database 2013 over the Internet as network 2021 via application server 2009. In certain embodiments, systems of the invention are deployed as applications or mobile apps installed on a single computing device, such as trial planner computer 2029 or research center computer 2025, operable to perform methods of the invention without regard to the instant availability of network 2021.

In various embodiments, machines of the invention can be, as necessary to perform the methodologies described herein, a personal computer (PC), a tablet PC (e.g., iPad, Samsung Galaxy tablet, Nexus 7 tablet computer sold by Google (Mountain View, Calif.), a set-top box (STB), a Personal Digital Assistant (PDA), a cellular telephone or smart phone, a web appliance, a network router, switch or bridge, or any machine capable of executing a set of instructions (sequential or otherwise) that specify actions to be taken by that machine. Further, while server 2005 is illustrated as a single machine, the term “machine” shall also be taken to include any collection of machines that individually or jointly execute a set (or multiple sets) of instructions to perform any one or more of the methodologies discussed herein. In some embodiments, server 2005 can include hardware such as a Hitachi Compute Blade 500 computer device sold by Hitachi Data Systems (Santa Clara, Calif.). A processor in a computer device can be, for example, an E5-2600 processor sold under the trademark Xeon by Intel Corporation (Santa Clara, Calif.).

In certain embodiments, one or more device of the invention is a custom device designed and constructed to implement methodologies described herein and is housed, for example, in a unique form-factor or a form-factor not typically associated with laptop, desktop, or tablet computers.

As one skilled in the art would recognize as necessary or best-suited for performance of the methods of the invention, trial planner computer 2029, research center computer 2025, or data server 2017 are also computer machines. In a preferred embodiment, they can each be one of: laptop, desktop, or handheld computing devices such as smartphones, iPhones, tablet computer, laptops, PDAs, computers, or e-readers.

A computer generally includes one or more input/output (I/O) device. Computer systems or machines according to the invention may further include a video display unit (e.g., a liquid crystal display (LCD) or a cathode ray tube (CRT)). Computer systems or machines according to the invention can also include an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (MC), Wi-Fi card, or cellular modem. Input-output devices generally includes one or a combination of monitor, keyboard, mouse, data jack (e.g., Ethernet port, modem jack, HDMI port, mini-HDMI port, USB port), Wi-Fi card, touchscreen (e.g., CRT, LCD, LED, AMOLED, Super AMOLED), pointing device, trackpad, microphone, speaker, light (e.g., LED), or light/image projection device.

A computer generally includes at least one processor. As one skilled in the art would recognize as necessary or best-suited for performance of the methods of the invention, computer systems or machines of the invention include one or more processors (e.g., a central processing unit (CPU) a graphics processing unit (GPU) or both), a main memory and a static memory, which communicate with each other via a bus. One of skill in the art will recognize that a processor may be provided by one or more processors including, for example, one or more of a single core or multi-core processor (e.g., AMD Phenom II X2, Intel Core Duo, AMID Phenom II X4, Intel Core i5, Intel Core i& Extreme Edition 980X, or Intel Xeon E7-2820). In certain embodiments, any of consumer computer 201, provider computer 281, production computer 261 may be a notebook or desktop computer sold by Apple (Cupertino, Calif.) or a desktop, laptop, or similar PC-compatible computer such as a Dell Latitude E6520 PC laptop available from Dell Inc. (Round Rock, Tex.). Such a computer will typically include a suitable operating system such as, for example, Windows 7, Windows 8, Windows XP, all from Microsoft (Redmond, Wash.), OS X from Apple (Cupertino, Calif.), or Ubuntu Linux from Canonical Group Limited (London, UK). In some embodiments, any of consumer computer 201, provider computer 281, production computer 261 may be a tablet or smart-phone form factor device and processor 281 can be provided by, for example, an ARM-based system-on-a-chip (SoC) processor such as the 1.2 GHz dual-core Exynos SoC processor from Samsung Electronics, (Samsung Town, Seoul, South Korea).

A computer generally includes memory. Computer memory generally refers to a machine-readable medium and may generally be present in the form of random access memory (RAM), read-only memory (ROM), or a combination thereof. A memory generally refers to one or more storage devices for storing data or carrying information, e.g., semiconductor, magnetic, magneto-optical disks, or optical disks. Information carriers for a memory suitable for embodying computer program instructions and data include any suitable form of memory that is tangible, non-transitory, non-volatile, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); magneto-optical disks; and optical disks (e.g., CD and DVD disks).

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories (e.g., subscriber identity module (SIM) card, secure digital card (SD card), or micro SD card), optical and magnetic media, and any other tangible storage media.

In some embodiments, a computer according to the invention includes a specialized device with processing or memory capabilities such as firmware, an application-specific integrated circuit (ASIC), or a field programmable gate array (FPGA). In general, firmware refers to a combination of persistent memory with program code and data stored in it. In general, an ASIC or an FPGA is an integrated circuit configured after manufacturing to operate as a device to implement methodologies of the invention. In some embodiments, a custom form-factor device or a device of the invention having a form factor other than a familiar laptop, tablet, or desktop computer form factor will include one or more of firmware, an ASIC, or an FPGA, and may further include I/O devices such as one or more of a monitor, button, switch, Ethernet port, Wi-Fi card, touchscreen, USB port, infrared device, or similar, or a combination thereof.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program may be deployed in any form, including as a stand-alone program or as a module, component, subroutine, or other unit suitable for use in a computing environment. A computer program (also known as a program, software, software application, app, macro, or code) can be written in any form of programming language, including compiled or interpreted languages (e.g., C, C++, Perl). Systems and methods of the invention can include instructions written in any suitable programming language known in the art, including, without limitation, C, C++, Perl, Java, ActiveX, HTML5, Python, Ruby on Rails, Visual Basic, or JavaScript. Programming in Java is discussed in Liang, Introduction to Java Programming, Comprehensive (8th Edition), Prentice Hall, Upper Saddle River, N.J. (2011) and in Poo, et al., Object-Oriented Programming and Java, Springer Singapore, Singapore, 322 p. (2008). A computer program may be developed in a development environment such as Ruby on Rails or Groovy and Grails. See, e.g., Metz, Practical Object-Oriented Design in Ruby: An Agile Primer, Addison-Wesley (2012).

In some embodiments, systems of the invention include data regarding clinical research centers stored in database 2013, e.g., within server 2005. A database application can be developed for use within server 2005. Any development environment, database, or language known in the art may be used to implement embodiments of the invention. In some embodiments, an object-oriented development language, database structure, or development environment is used. Exemplary languages, systems, and development environments for development and operation of database 2013 include Perl, C++, Python, Ruby on Rails, JAVA, Groovy and Grails, Visual Basic .NET, Smalltalk, Objective C, and SQL (e.g., in the context of a Relational Database Management System such as MySQL, Oracle, Informix, or Postgres). In some embodiments, implementations of the invention provide one or more object-oriented application and underlying databases for use with the applications. Databases are discussed in Date, C. J., Database design and relational theory, 2012, O'Reilly Media, Inc., Sebastopol, Calif., 260 pages, and Teorey, et al., Database Modeling and Design, 2011, Elsevier, Burlington, Mass., 304 pages.

In some embodiments, systems and methods of the invention can be developed using the Groovy programming language and the web development framework Grails or a similar product. Grails is an open source model-view-controller (MVC) web framework and development platform that provides domain classes that carry application data for display by the view. Grails domain classes can generate the underlying database schema. Grails provides a development platform for applications including web applications, as well as a database and an object relational mapping framework called Grails Object Relational Mapping (GORM). The GORM can map objects to relational databases and represent relationships between those objects. GORM relies on the Hibernate object-relational persistence framework to map complex domain classes to relational database tables. Grails further includes the Jetty web container and server and a web page layout framework (SiteMesh) to create web components. Groovy and Grails are discussed in Judd, et al., Beginning Groovy and Grails, Apress, Berkeley, Calif., 414 p. (2008) and in Brown, The Definitive Guide to Grails, Apress, Berkeley, Calif., 618 p. (2009).

In certain embodiments, systems and methods of the invention are implemented through the use of a mobile app. As used herein, mobile app generally refers to a standalone program capable of being installed or run on a smartphone platform such as Android, iOS, Blackberry OS, Windows 8, Windows Mobile, etc.

Functionality of the invention can be implemented by a mobile app or a software application or computer program in other formats included scripts, shell scripts, and functional modules created in development environments.

A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium such as any of those discussed above. A file can be sent from one device to another over network 2001 (e.g., as packets being sent between a server and a client, for example, through a Network Interface Card, modem, wireless card, or similar).

The software may also reside, completely or at least partially, within the main memory and/or within the processor during execution thereof by the computer system, the main memory and the processor also constituting machine-readable media. Exemplary systems and system architectures for use with the invention are described in U.S. Pub. 2011/0209133, U.S. Pub. 2011/0175923, and U.S. Pub. 2007/0112800, each of which is incorporated by reference herein in its entirety.

The software may further be transmitted or received over network 2021 via the network interface device.

Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user (e.g., a physical arrangement of particles that indicates that a specific research center has a specific capacity to participate in a clinical trial). In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NAND flash memory device and storing information by transforming physical elements in an array of memory cells made from floating-gate transistors. Methods of writing a file can be invoked manually or automatically by a program or by a save command from software or a write command from a programming language.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for compiling a network for research centers, the method comprising:
using a system comprising a tangible, non-transitory memory coupled to a processor to:
retrieve data describing a clinical trial in which a plurality of entities collaborated;
analyze the data to identify each of the entities;
compose, for each entity, a list of trials in which that entity collaborated; and
provide, for each entity, a profile that includes the list for the entity.

2. The method of claim 1, wherein the entities are clinical research centers.

3. The method of claim 1, wherein analyzing the data involves the use of regular expressions.

4. The method of claim 1, further comprising, for one of the entities, allowing a person to edit the list and causing the edited list to be displayed in the profile.

5. The method of claim 1, wherein the entities are investigators.

6. The method of claim 5, further comprising allowing each investigator to edit their profile

7. A method of using a clinical research center network, the method comprising:
storing, in a computer system comprising a memory coupled to a processor, a profile describing a physician and a multisite clinical trial at a research center that the physician has participated in;
receiving data from the physician establishing a link between the physician and a second multisite clinical trial;
updating the profile to include the data and the link; and
providing a planner with access to the profile.

8. The method of claim 7, further comprising receiving, from the physician, information about a clinical capacity linked to a disease at the research center, and storing the information in a center profile for the research center.

9. The method of claim 7, wherein the profile is displayed to the planner including a link that causes the display of a center profile for the research center.

10. A system for compiling a network of historical collaborations, the system comprising:
a non-transitory memory coupled to a processor, wherein the system is operable to:
retrieve over a communications network a plurality of items, each item indicating a clinical trial in which entities collaborated;
identify the entities that collaborated in each clinical trial;
compose, for each entity, a list of clinical trials in which that entity collaborated, the list including the identity of co-collaborating entities;
provide access to the list.

11. The system of claim 10, wherein the entities are investigators.

12. The system of claim 10, wherein the entities are clinical research centers.

13. The system of claim 10, wherein identifying the entity involves the use of regular expressions.

14. The system of claim 10, further comprising allowing a person to edit the list and subsequently displaying the list on a profile web page.

15. A system for compiling a list of clinical trial credentials, the system comprising a tangible, non-transitory memory coupled to a processor, the processor operable to:
retrieve over a communications network a plurality of items, each item indicating a competency to perform a clinical trial;
execute computer program instructions to identify an investigator name within the items and a title;
compose, for the investigator name, a list of associated titles and save the list in the memory;
provide the list for access by the investigator.

16. The system of claim 15, wherein the items are digital records of publications and the titles are the titles of the publications.

17. The system of claim 15, wherein the items are clinical trials.

18. The system of claim 15, wherein the plurality of items are retrieved from an online library database.

19. The system of claim 15, wherein the plurality of items are retrieved from a database of clinical trials.

20. The system of claim 15, wherein identifying the investigator name involves the use of regular expressions.

21. The system of claim 15, further comprising allowing the investigator to edit the list and subsequently displaying the list on a profile web page.

22. A method for compiling a list of clinical trial credentials, the method comprising using a tangible, non-transitory memory coupled to a processor to perform the steps of:
retrieving over a communications network a plurality of items, each item indicating a competency to perform a clinical trial;
executing computer program instructions to identify an entity name within each item;
composing, each entity name, a list of associated competencies;
providing the list for access by a person.

23. The method of claim 22, wherein each item is a digital record of a publication and each competency identifies a medical test referred to in the item.

24. The method of claim 23, wherein each entity is a researcher.

25. The method of claim 23, wherein each entity is a research institution.

26. The method of claim 22, wherein each item comprises a web page of a research center, each entity comprises a research center, and each competency comprises a clinical procedure.

27. The method of claim 22, wherein each item comprises a web page of a research center, each entity comprises a researcher, and each competency comprises a clinical procedure.

28. The method of claim 22, wherein the entities comprise a plurality of researchers and the person is one of the plurality of researchers.

29. The method of claim 28, wherein the list is a provided as a profile, and further comprising allowing the person to link the profile to profiles of other entities.

30. The method of claim 29, further comprising allowing the other entities to confirm the links.
